(19) United States
(12) Patent Application Publication
(10) Pub. No.: US 2025/0208467 A1
(43) Pub. Date: Jun. 26, 2025

(54) WAVELENGTH CONVERSION MEMBER AND MANUFACTURING METHOD THEREFOR

(71) Applicant: NICHIA CORPORATION, Anan-shi (JP)

(72) Inventors: Takuma ARIKAWA, Tokushima-shi (JP); Masafumi KURAMOTO, Tokushima-shi (JP); Takayoshi WAKAKI, Anan-shi (JP)

(73) Assignee: NICHIA CORPORATION, Anan-shi (JP)

(21) Appl. No.: 18/847,677

(22) PCT Filed: Mar. 3, 2023
(86) PCT No.: PCT/JP2023/008034

§ 371 Date: Sep. 16, 2024

(30) Foreign Application Priority Data
Mar. 18, 2022 (JP) 2022-043592
Jul. 4, 2022 (JP) 2022-107776
Jan. 18, 2023 (JP) 2023-005794

(51) Int. Cl. G02F 1/1335; B23K 26/38

(52) U.S. Cl. CPC G02F 1/133614; B23K 26/38; G02F 2202/36

(57) ABSTRACT

Provided is a wavelength conversion member in which discoloration from an end portion is inhibited. The wavelength conversion member includes a laminate that includes: a wavelength conversion layer containing quantum dots; and two barrier layers each laminated on one of main surfaces of the wavelength conversion layer and on the other main surface. In this wavelength conversion member, the barrier layers each have a first modification part on at least a portion of their end surfaces, the wavelength conversion layer has a second modification part on at least a portion of its end surface, and the second modification part is at least partially exposed on an end surface of the laminate.

### TECHNICAL FIELD

The present disclosure relates to a wavelength conversion member and a method of producing the same.

### BACKGROUND ART

In the field of image display devices such as liquid crystal display devices, it has been proposed to utilize quantum dots that convert the wavelength of incident light and emit light with the intention of improving color reproducibility. For example, WO 2016/039079 proposes a functional laminated film that includes: a functional layer laminate having a functional layer containing quantum dots, and two gas barrier films; and an end surface protective layer covering the end surface of the functional layer.

### SUMMARY OF INVENTION

### Technical Problem

In a sheet-form wavelength conversion member containing quantum dots, there are cases where discoloration proceeds from an end portion over time. An object of one aspect of the present disclosure is to provide: a wavelength conversion member in which discoloration from an end portion is inhibited; and a method of producing the same.

### Solution to Problem

A first aspect is a wavelength conversion member including a laminate that includes: a wavelength conversion layer containing quantum dots; and two barrier layers each laminated on one of main surfaces of the wavelength conversion layer and on the other main surface. The barrier layers each have a first modification part on at least a portion of their end surfaces, and the wavelength conversion layer has a second modification part on at least a portion of its end surface. In this wavelength conversion member, the second modification part is at least partially exposed on an end surface of the laminate.

A second aspect is a method of producing a wavelength conversion member, the method including: preparing a laminated sheet that includes a wavelength conversion layer containing quantum dots, and two barrier layers each laminated on one of main surfaces of the wavelength conversion layer and on the other main surface; and cutting the laminated sheet by irradiation with a laser beam intersecting the main surfaces of the laminated sheet to obtain a singulated laminate. The irradiation with the laser beam is performed at a laser beam frequency that is 5 kHz to 30 kHz, a scanning speed that is 50 mm/s to 100 mm/s, and a laser beam output that is 3.4 W to 100 W.

### Advantageous Effects of Invention

According to one aspect of the present disclosure, a wavelength conversion member in which discoloration from an end portion is inhibited, and a method of producing the same can be provided.

### BRIEF DESCRIPTION OF DRAWINGS

FIG. 1 is an example of an X-ray diffraction pattern of the nanoparticle precursor according to Reference Example 1.

FIG. 2 is an example of a transmission electron micrograph of the quantum dots according to Reference Example 1.

FIG. 3 is a schematic cross-sectional view illustrating an aspect of an end portion of a laminate.

FIG. 4 is an example of a reflected electron image of a cut surface of the wavelength conversion member according to Comparative Example 1, in which the cut surface was made using a cutting machine.

FIG. 5 is an example of a reflected electron image of a cut surface of the wavelength conversion member according to Example 3, in which the cut surface was made using a laser beam.

FIG. 6 is an example of a fluorescence micrograph of a cross-section of an end portion of the wavelength conversion member according to Comparative Example 1, in which the cross-section was made using a cutting machine.

FIG. 7 is an example of a fluorescence micrograph of a cross-section of an end portion of the wavelength conversion member according to Example 3, in which the cross-section was made using a laser beam.

FIG. 8 is a schematic cross-sectional view illustrating an aspect of a wavelength conversion member.

### DESCRIPTION OF EMBODIMENTS

The term “step” used herein encompasses not only a discrete step but also a step that cannot be clearly distinguished from other steps, as long as the intended purpose of the step is achieved. When there are plural substances that correspond to a component of a composition, an indicated amount of the component contained in the composition means, unless otherwise specified, a total amount of the plural substances existing in the composition. Further, as an upper limit and a lower limit of a numerical range described in the present specification, values exemplified for the numerical range can be arbitrarily selected and combined. In the present specification, the relationships between color names and chromaticity coordinates, the relationships between wavelength ranges of light and color names of monochromatic light, and the like conform to JIS Z8110. A “half-value width” of a phosphor means, in an emission spectrum of a light emitting material, a wavelength width at which the emission intensity is 50% relative to the maximum emission intensity (full-width at half maximum; FWHM). The terms “sheet”, “film”, “layer”, and the like used herein are not distinguished from each other solely based on a difference in appellation. Accordingly, for example, the terms “film” and “layer” are used in a meaning that encompasses a member referred to as “sheet”, and the terms “sheet” and “layer” are used in a meaning that encompasses a member that can be referred to as “film”. The term “layer” used herein encompasses, when a region having the layer is observed, not only a case where the layer is formed on the entirety of the region but also a case where the layer is formed on only a part of the region. The term “laminate” used herein refers to stacking of layers, where two or more of the layers may be bonded with each other, or may be detachable from each other. In the present specification, for “wavelength conversion layer”, “barrier layer”, and the like, the same term may be used before and after cutting. It is noted here that the dimensions, the positional relations, and the like of members illustrated in the drawings may be exaggerated for clarity of description. In the following description, the same names and symbols denote the same members or members of the same quality, and a detailed description thereof is omitted as appropriate. Moreover, the elements constituting the present invention may take a mode where plural elements are constituted by the same member so that a single member doubles as the plural elements or, conversely, a function of a single member may be shared and realized by plural members. In the present specification, a description of a layer, a film, or the like to be “on” or “above” other component encompasses not only a case where the layer, the film, or the like is “directly on” the other component, but also a case where another component is provided therebetween. Furthermore, a component arranged “on” another component encompasses not only a case where the component is arranged on the upper side of another component, but also a case where the component is arranged on the lower side of another component. Embodiments of the present invention will now be described in detail. It is noted here, however, that the below-described embodiments are merely examples of a wavelength conversion member and a method of producing the same that embody the technical ideas of the present invention, and the present invention is not limited to the below-described wavelength conversion member and method of producing the same.

### Wavelength Conversion Member

A wavelength conversion member includes a laminate that includes: a wavelength conversion layer containing quantum dots; and two barrier layers each laminated on one of main surfaces of the wavelength conversion layer and on the other main surface. The barrier layers each have a first modification part on at least a portion of their end surfaces, and the wavelength conversion layer has a second modification part on at least a portion of its end surface. In the laminate constituting the wavelength conversion member, the second modification part is at least partially exposed on an end surface of the laminate. The wavelength conversion member may include the laminate, and an end surface covering layer that is arranged to cover the end surface of the laminate.

On the end surface of the laminate that includes the two barrier layers and the wavelength conversion layer, the first modification part and the second modification part are each formed by, for example, irradiation with a laser beam, whereby discoloration from an end portion of the wavelength conversion member with time is inhibited. This can be thought to be because the first modification part and the second modification part that are capable of sufficiently inhibiting the intrusion of moisture and the like are formed by irradiating the laser beam under such conditions that, for example, the second modification part is at least partially exposed on the end surface of the laminate. It may also be thought to be because the first modification part covers boundaries between the respective barrier layers and the wavelength conversion layer, and this inhibits the effects of the external environment through the boundaries.

The laminate has two opposing main surfaces and an end surface that surrounds the periphery of the main surfaces in the lamination direction. The opposing main surfaces each correspond to a main surface of the respective barrier layers. The end surface of the laminate is arranged along the periphery of the main surfaces and composed of a surface intersecting the main surfaces. The end surface of the laminate may be substantially perpendicular to, for example, the main surfaces of the laminate. The periphery of the main surfaces of the laminate may be surrounded by four flat end surfaces, or by end surfaces including at least one curved end surface.

The wavelength conversion layer contains quantum dots. The term “quantum dots” used herein refers to semiconductor crystal particles having a particle size of several nanometers to several tens of nanometers. When the size of a substance is reduced to the order of nanometers, electrons in the substance can exist only in a limited state. This makes the state of the electrons discrete, and the band-gap varies depending on the particle size. The quantum dots absorb light and emit a light having a wavelength corresponding to their band-gap energy. Therefore, the emission wavelength of the quantum dots can be controlled by controlling the particle size, the crystal composition, and the like, and the quantum dots are allowed to function as a wavelength conversion substance. The quantum dots contained in the wavelength conversion layer may have a particle size of, for example, 50 nm or less. The particle size of the quantum dots may be preferably 1 nm to 20 nm, 1.6 nm to 8 nm, or 2 nm to 7.5 nm.

It is noted here that the particle size of each semiconductor nanoparticle constituting the quantum dots refers to the length of the longest line segment among those line segments that connect any two points on the circumference of the particle observed in a transmission electron microscope (TEM) image and pass through the center of the particle. An average particle size of semiconductor nanoparticles means a value obtained by measuring the particle size of each measurable semiconductor nanoparticle observed in a TEM image and calculating the arithmetic mean of the thus measured values.

When the semiconductor nanoparticles are rod-shaped particles, the length of the short axis is regarded as the particle size of each particle. The term “rod-shaped particle” used herein refers to a particle that is observed to have, for example, a quadrangular shape such as a rectangular shape elongated in one direction (a cross-section has a circular, elliptical, or polygonal shape), an elliptical shape, or a polygonal shape (e.g., a pencil-like shape) when the surface including the long axis is observed, and in which a ratio of the length of the long axis with respect to the length of the short axis is higher than 1.2. For a rod-shaped particle having an elliptical shape, the length of the long axis means the length of the longest line segment among those line segments connecting any two points on the circumference of the particle and, for a rod-shaped particle having a rectangular or polygonal shape, the length of the long axis means the length of the longest line segment among those line segments that are parallel to the longest side among all sides defining the circumference of the particle and connect any two points on the circumference of the particle. The length of the short axis means the length of the longest line segment that is perpendicular to the line segment defining the length of the long axis, among those line segments connecting any two points on the circumference of the particle. Specifically, the average particle size of the semiconductor nanoparticles is determined by measuring the particle size for all measurable semiconductor nanoparticles observed in a TEM image captured at a magnification of ×50,000 to ×150,000, and calculating the arithmetic mean of the thus measured values. The “measurable” particles are those particles whose outlines are entirely observable in a TEM image. Accordingly, in a TEM image, a particle that is partially not included in the captured area and thus appears to be “cut” is not a measurable particle. When a single TEM image contains a total of 100 or more nanoparticles, the average particle size is determined using the single TEM image. When the number of nanoparticles contained in the single TEM image is small, another TEM image is further captured at a different position, and the particle size is measured for 100 or more particles contained in two or more TEM images to determine the average particle size.

Specific examples of the quantum dots include perovskite quantum dots, chalcopyrite quantum dots, and indium phosphide (InP) quantum dots. The perovskite quantum dots may contain, for example, a compound represented by the following Formula (1):

[M¹_{w}A¹_{(1-w)}]ₓM²_{y}X_{z} (1)

In Formula (1), M¹ represents a first element including at least one selected from the group consisting of Cs, Rb, K, Na, and Li; A¹ represents a non-metal cation including at least one selected from the group consisting of an ammonium ion, a formamidinium ion, a guanidinium ion, an imidazolium ion, a pyridinium ion, a pyrrolidinium ion, and a protonated thiourea ion; M² represents a second element including at least one selected from the group consisting of Ge, Sn, Pb, Sb, and Bi; X represents an anion or a ligand, which includes at least one selected from the group consisting of a chloride ion, a bromide ion, an iodide ion, a cyanide ion, a thiocyanate, an isothiocyanate, and a sulfide; x represents a number of 1 to 4; y represents a number of 1 to 2; z represents a number of 3 to 9; and w represents a number of 0 to 1. When the first element M¹ and the non-metal cation A¹ are both contained in Formula (1), the first element M¹ and the non-metal cation A¹ together represent an atomic group constituting a ligand.

The ammonium ion may be represented by, for example, the following Formula (A-1). The formamidinium ion may be represented by, for example, the following Formula (A-2). The guanidinium ion may be represented by, for example, the following Formula (A-3). The protonated thiourea ion may be represented by, for example, the following Formula (A-4). The imidazolium ion may be represented by, for example, the following Formula (A-5). The pyridinium ion may be represented by, for example, the following Formula (A-6). The pyrrolidinium ion may be represented by, for example, the following Formula (A-7). In these Formulae representing non-metal cations, Rs each independently represent at least one selected from the group consisting of a hydrogen atom, an alkyl group having 1 to 4 carbon atoms, a phenyl group, a benzyl group, a halogen atom, and a pseudo-halogen. In each Formula, any two Rs may be linked with each other to form a nitrogen-containing aliphatic ring having 3 to 6 carbon atoms.

[R₄N⁺] (A-1)

[(NR₂)₂RC⁺] (A-2)

[(NR₂)₃C⁺] (A-3)

[(NR₂)₂C⁺—SR] (A-4)

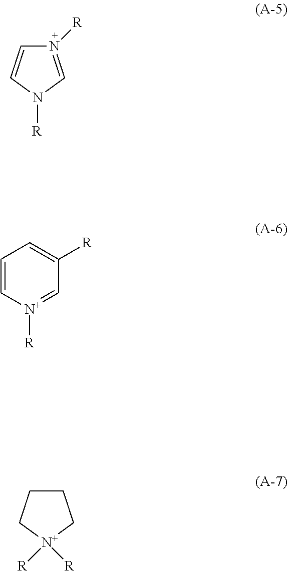

The perovskite quantum dots that contain a compound having a composition represented by the above-described Formula (1) emit a green light or a red light when irradiated with a light emitted from a light source. With regard to the green light, the perovskite quantum dots may emit a light having a peak emission wavelength in a range of 475 nm to 560 nm when irradiated with a light emitted from a light source having a peak emission wavelength in a range of, for example, 380 nm to 545 nm, preferably a light source having a peak emission wavelength in a range of, for example, 380 nm to 500 nm. The peak emission wavelength of the perovskite quantum dots emitting the green light may be in a range of preferably 510 nm to 560 nm, 520 nm to 560 nm, or 525 nm to 535 nm. Further, with regard to the red light, the perovskite quantum dots may emit a light having a peak emission wavelength in a range of 600 nm to 680 nm when irradiated with a light emitted from a light source having a peak emission wavelength in a range of, for example, 320 nm to 545 nm, preferably a light source having a peak emission wavelength in a range of, for example, 320 nm to 450 nm. The peak emission wavelength of the perovskite quantum dots emitting the red light may be in a range of preferably 610 nm to 670 nm, 620 nm to 660 nm, or 625 nm to 635 nm. Moreover, in an emission spectrum of the perovskite quantum dots, the half-value width may be, for example, 35 nm or less, preferably 30 nm or less, or 25 nm or less. The perovskite quantum dots may exhibit band-edge emission in the emission spectrum.

In a first aspect of the chalcopyrite quantum dots, for example, the chalcopyrite quantum dots may contain a first semiconductor containing silver (Ag), indium (In), gallium (Ga), and sulfur (S), and may be configured such that a second semiconductor containing Ga and S is arranged on the surfaces of the chalcopyrite quantum dots. The second semiconductor may further contain Ag. The first semiconductor may be a semiconductor that has a chalcopyrite-type structure containing Ag, In, Ga, and S. In the first aspect of the chalcopyrite quantum dots, a deposit containing the second semiconductor may be arranged on the surfaces of particles containing the first semiconductor, and the particles containing the first semiconductor may be covered with the deposit containing the second semiconductor. Further, the chalcopyrite quantum dots may have a core-shell structure in which, for example, a particle containing the first semiconductor constitutes a core and a deposit containing the second semiconductor is arranged as a shell on the surface of the core. With regard to the details of the chalcopyrite quantum dots of the first aspect, reference can be made to, for example, Japanese Laid-Open Patent Publication No. 2018-044142 and WO 2022/191032.

The first semiconductor contains at least Ag that may be partially substituted such that the first semiconductor further contains at least one of copper (Cu), gold (Au), or an alkali metal (hereinafter, may be denoted as M^{a}), or the first semiconductor may be composed of substantially Ag. The term “substantially” used herein indicates that a ratio of the number of atoms of Ag-substituting elements other than Ag is, for example, 10% or lower, preferably 5% or lower, more preferably 1% or lower, with respect to a total number of atoms of Ag and the Ag-substituting elements other than Ag. Further, the first semiconductor may contain substantially Ag and an alkali metal as constituent elements. The term “substantially” used herein indicates that a ratio of the number of atoms of the Ag-substituting elements other than Ag and the alkali metal is, for example, 10% or lower, preferably 5% or lower, more preferably 1% or lower, with respect to a total number of atoms of Ag, the alkali metal, and the Ag-substituting elements other than Ag and the alkali metal. Examples of the alkali metal include lithium (Li), sodium (Na), potassium (K), rubidium (Rb), and cesium (Cs).

The first semiconductor may have a composition represented by, for example, the following Formula (2a):

(AgₚM^{a}₍₁₋ₚ₎)_{q}In_{z}Ga₍₁₋ᵣ₎S_{(q+3)/2} (2a)
wherein, p, q, and r satisfy 0<p≤1, 0.20<q≤1.2, and 0<r<1; and M^{a} represents an alkali metal.

In the first aspect of the chalcopyrite quantum dots, the second semiconductor may be arranged on the surfaces of the chalcopyrite quantum dots. The second semiconductor may contain a semiconductor having a larger band-gap energy than that of the first semiconductor. The second semiconductor may be a semiconductor composed of substantially Ga and S. Alternatively, the second semiconductor may be a semiconductor composed of substantially Ag, Ga, and S. The term “substantially” used herein indicates that, when a total number of atoms of all elements contained in a semiconductor containing Ga and S or a semiconductor containing Ag, Ga, and S is taken as 100%, a ratio of the number of atoms of elements other than Ga and S or elements other than Ag, Ga, and S is, for example, 10% or lower, preferably 5% or lower, more preferably 1% or lower.

The chalcopyrite quantum dots of the first aspect may exhibit band-edge emission having a peak emission wavelength in a wavelength range of 475 nm to 560 nm (e.g., green color) when irradiated with a light emitted from a light source having a peak emission wavelength in a range of, for example, 380 nm to 545 nm, and the peak emission wavelength may be in a range of preferably 510 nm to 550 nm, 515 nm to 545 nm, or 525 nm to 535 nm. Further, in an emission spectrum of the chalcopyrite quantum dots of the first aspect, the half-value width may be, for example, 45 nm or less, preferably 40 nm or less, 35 nm or less, or 30 nm or less. The half-value width may be, for example, 15 nm or more.

In a second aspect of the chalcopyrite quantum dots, for example, the chalcopyrite quantum dots may contain a third semiconductor containing copper (Cu), silver (Ag), indium (In), gallium (Ga), and sulfur (S), and may be configured such that a fourth semiconductor containing Ga and S is arranged on the surfaces of the chalcopyrite quantum dots. The fourth semiconductor may further contain Ag. The third semiconductor may be a semiconductor that has a chalcopyrite-type structure containing Cu, Ag, In, Ga, and S. In the second aspect of the chalcopyrite quantum dots, a deposit containing the fourth semiconductor may be arranged on the surfaces of particles containing the third semiconductor, and the particles containing the third semiconductor may be covered with the deposit containing the fourth semiconductor. Further, the chalcopyrite quantum dots may have a core-shell structure in which, for example, a particle containing the third semiconductor constitutes a core and a deposit containing the fourth semiconductor is arranged as a shell on the surface of the core. With regard to the details of the chalcopyrite quantum dots of the second aspect, reference can be made to, for example, WO 2020/162622 and WO 2023/013361.

The third semiconductor contains at least Ag and Cu that may be partially substituted such that the third semiconductor also contains gold (Au) and an alkali metal (M^{a}), or the first semiconductor may be composed of substantially Ag. The third semiconductor may contain substantially Ag, Cu, and an alkali metal as constituent elements. The term “substantially” used herein indicates that a ratio of the number of atoms of elements other than Ag, Cu, and the alkali metal is, for example, 10% or lower, preferably 5% or lower, more preferably 1% or lower, with respect to a total number of atoms of Ag, Cu, the alkali metal, and the elements other than Ag, Cu, and the alkali metal.

The third semiconductor may have a composition represented by, for example, the following Formula (2b):

(AgₛCu₍₁₋ₛ₎)ₜInᵤGa₍₁₋ᵤ₎S_{(t+3)/2} (2b)
wherein, s, t, and u satisfy 0<s<1, 0.20<t≤1.2, 0<u<1.

In the second aspect of the chalcopyrite quantum dots, the fourth semiconductor may be arranged on the surfaces of the chalcopyrite quantum dots. The fourth semiconductor may contain a semiconductor having a larger band-gap energy than that of the third semiconductor. The fourth semiconductor may be a semiconductor composed of substantially Ga and S. Alternatively, the fourth semiconductor may be a semiconductor composed of substantially Ag, Ga, and S. The term “substantially” used herein indicates that, when a total number of atoms of all elements contained in a semiconductor containing Ga and S or a semiconductor containing Ag, Ga, and S is taken as 100%, a ratio of the number of atoms of elements other than Ga and S or elements other than Ag, Ga, and S is, for example, 10% or lower, preferably 5% or lower, more preferably 1% or lower.

The chalcopyrite quantum dots of the second aspect may exhibit band-edge emission having a peak emission wavelength in a wavelength range of 600 nm to 680 nm (e.g., red color) when irradiated with a light emitted from a light source having a peak emission wavelength in a range of, for example, 380 nm to 545 nm, and the peak emission wavelength may be in a range of preferably 610 nm to 670 nm, 620 nm to 660 nm, or 625 nm to 635 nm. Further, in an emission spectrum of the chalcopyrite quantum dots of the second aspect, the half-value width may be, for example, 70 nm or less, preferably 65 nm or less, 60 nm or less, or 30 nm or less. The half-value width may be, for example, 15 nm or more.

In a third aspect of the chalcopyrite quantum dots, for example, the chalcopyrite quantum dots may contain a fifth semiconductor containing silver (Ag), gallium (Ga), and selenium (Se), and may be configured such that a sixth semiconductor containing zinc (Zn) and S (sulfur) is arranged on the surfaces of the chalcopyrite quantum dots. The fifth semiconductor contains at least Ag, Ga, and Se that may be partially substituted such that the fifth semiconductor also contains indium (In) and sulfur (S). The sixth semiconductor may further contain at least one of Ga or Se. The fifth semiconductor may be a semiconductor that has a chalcopyrite-type structure containing Ag, Ga, and Se. In the third aspect of the chalcopyrite quantum dots, a deposit containing the sixth semiconductor may be arranged on the surfaces of particles containing the fifth semiconductor, and the particles containing the fifth semiconductor may be covered with the deposit containing the sixth semiconductor. Further, the chalcopyrite quantum dots may have a core-shell structure in which, for example, a particle containing the fifth semiconductor constitutes a core and a deposit containing the sixth semiconductor is arranged as a shell on the surface of the core. With regard to the details of the chalcopyrite quantum dots of the third aspect, reference can be made to, for example, WO 2021/039290.

The fifth semiconductor contains at least Ag, Ga, and Se that may be partially substituted such that the fifth semiconductor also contains indium (In) and sulfur (S).

The fifth semiconductor may have a composition represented by, for example, the following Formula (2c):

AgInₓGa₁₋ₓS_{y}Se_{1-y} (2c)
wherein, x and y satisfy 0≤x<1 and 0≤y≤1.

In the third aspect of the chalcopyrite quantum dots, the sixth semiconductor may be arranged on the surfaces of the chalcopyrite quantum dots. The sixth semiconductor may contain a semiconductor having a larger band-gap energy than that of the fifth semiconductor. The sixth semiconductor may be a semiconductor composed of substantially Zn and S. The term “substantially” used herein indicates that, when a total number of atoms of all elements contained in a semiconductor containing Zn and S is taken as 100%, a ratio of the number of atoms of elements other than Zn and S is, for example, 10% or lower, preferably 5% or lower, more preferably 1% or lower.

The chalcopyrite quantum dots of the third aspect may exhibit band-edge emission having a peak emission wavelength in a wavelength range of 600 nm to 680 nm (e.g., red color) when irradiated with a light emitted from a light source having a peak emission wavelength in a range of, for example, 380 nm to 545 nm, and the peak emission wavelength may be in a range of preferably 610 nm to 670 nm, or 625 nm to 635 nm. Further, in an emission spectrum of the chalcopyrite quantum dots of the third aspect, the half-value width may be, for example, 50 nm or less, preferably 40 nm or less, or 30 nm or less. The half-value width may be, for example, 15 nm or more.

The indium phosphide (InP) quantum dots are one form of semiconductor nanoparticles containing a Group III-V semiconductor. Examples of the Group III-V semiconductor include AlN, AlP, AlAs, AlSb, GaAs, GaP, GaN, GaSb, InN, InAs, InP, InSb, TiN, TiP, TiAs, and TiSb.

In Group III-V quantum dots, on the surfaces of semiconductor nanoparticles containing a Group III-V semiconductor, a deposit containing a seventh semiconductor different from the Group III-V semiconductor constituting the semiconductor nanoparticles may be arranged, and the particles containing the Group III-V semiconductor may be covered with the deposit containing the seventh semiconductor. Further, the Group III-V quantum dots may have a core-shell structure in which, for example, a particle containing the Group III-V semiconductor constitutes a core and a deposit containing the seventh semiconductor is arranged as a shell on the surface of the core. The seventh semiconductor may be a semiconductor having a larger band-gap energy than that of the Group III-V semiconductor. Examples of a combination of the Group III-V semiconductor and the seventh semiconductor include InP/ZnS, GaP/ZnS, InN/GaN, InP/CdSSe, InP/ZnSeTe, InGaP/ZnSe, InGaP/ZnS, InP/ZnSTe, InGaP/ZnSTe, and InGaP/ZnSSe.

The Group III-V semiconductor (e.g., indium phosphide) quantum dots may emit a green light or a red light when irradiated with a light emitted from a light source having a peak emission wavelength in a range of, for example, 380 nm to 500 nm. The Group III-V semiconductor quantum dots emitting a green light may exhibit band-edge emission having a peak emission wavelength in a range of 475 nm to 580 nm when irradiated with a light emitted from a light source having a peak emission wavelength in a range of, for example, 380 nm to 545 nm, preferably a light source having a peak emission wavelength in a range of, for example, 380 nm to 500 nm. The peak emission wavelength may be in a range of preferably 510 nm to 570 nm, 520 nm to 560 nm, or 525 nm to 535 nm. Further, the Group III-V semiconductor quantum dots emitting a red light may exhibit band-edge emission having a peak emission wavelength in a range of 600 nm to 680 nm when irradiated with a light emitted from a light source having a peak emission wavelength in a range of, for example, 380 nm to 545 nm. The peak emission wavelength may be in a range of preferably 610 nm to 670 nm, 620 nm to 660 nm, or 625 nm to 635 nm. Further, in an emission spectrum of the Group III-V semiconductor quantum dots, the half-value width may be, for example, 70 nm or less, preferably 65 nm or less, 60 nm or less, or 30 nm or less. The half-value width may be, for example, 15 nm or more.

The quantum dots, if necessary, may also contain other quantum dots in addition to the perovskite quantum dots, the chalcopyrite quantum dots, and the indium phosphide quantum dots. Examples of the other quantum dots include particles containing at least one selected from the group consisting of Group II-VI semiconductors, Group IV-VI semiconductors, and Group IV semiconductors.

Specific examples of the Group II-VI semiconductors include CdSe, CdTe, CdS, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, CdZnSeS, CdZnSeTe, CdZnSTe, CdHgSeS, CdHgSeTe, CdHgSTe, HgZnSeS, HgZnSeTe, and HgZnSTe. Specific examples of the Group IV-VI semiconductors include SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe. Specific examples of the Group IV semiconductors include Si, Ge, SiC, and SiGe.

A surface modifier may be arranged on the surfaces of the quantum dots. Specific examples of the surface modifier include: an amino alcohol having 2 to 20 carbon atoms; an ionic surface modifier; a nonionic surface modifier; a nitrogen-containing compound containing a hydrocarbon group having 4 to 20 carbon atoms; a sulfur-containing compound containing a hydrocarbon group having 4 to 20 carbon atoms; an oxygen-containing compound containing a hydrocarbon group having 4 to 20 carbon atoms; a phosphorus-containing compound containing a hydrocarbon group having 4 to 20 carbon atoms; and a halide containing at least one selected from the group consisting of Group 2 elements, Group 12 elements, and Group 13 elements. These surface modifiers may be used singly, or in combination of two or more different kinds thereof.

The amino alcohol used as the surface modifier may be any compound as long as it has an amino group and an alcoholic hydroxy group and contains a hydrocarbon group having 2 to 20 carbon atoms. The number of carbon atoms in the amino alcohol is preferably 10 or less, more preferably 6 or less. The hydrocarbon group constituting the amino alcohol may be derived from a hydrocarbon such as a linear, branched, or cyclic alkane, alkene, or alkyne. The expression “derived from a hydrocarbon” used herein means that the hydrocarbon group is formed by removing at least two hydrogen atoms from the hydrocarbon. Specific examples of the amino alcohol include amino ethanol, amino propanol, amino butanol, amino pentanol, amino hexanol, and amino octanol. For example, the amino group of the amino alcohol binds to the surface of the respective semiconductor nanoparticles and the hydroxy group is exposed on the particle outermost surface on the opposite side, as a result of which the polarity of the semiconductor nanoparticles is changed, and the dispersibility in alcohol-based solvents (e.g., methanol, ethanol, propanol, and butanol) is improved.

Examples of the ionic surface modifier used as the surface modifier include nitrogen-containing compounds, sulfur-containing compounds, and oxygen-containing compounds, which contain an ionic functional group in their molecules. The ionic functional group may be either cationic or anionic, and the ionic surface modifier preferably contains at least a cationic group. With regard to specific examples of the surface modifier and a surface modification method, reference can be made to, for example, Chemistry Letters, Vol. 45, pp 898-900, 2016.

The ionic surface modifier may be, for example, a sulfur-containing compound containing a tertiary or quaternary alkylamino group. The number of carbon atoms of the alkyl group in the alkylamino group may be, for example, 1 to 4. The sulfur-containing compound may also be an alkyl or alkenylthiol having 2 to 20 carbon atoms. Specific examples of the ionic surface modifier include hydrogen halides of dimethylaminoethanethiol, halogen salts of trimethylammonium ethanethiol, hydrogen halides of dimethylaminobutanethiol, and halogen salts of trimethylammonium butanethiol.

Examples of the nonionic surface modifier used as the surface modifier include nitrogen-containing compounds, sulfur-containing compounds, and oxygen-containing compounds, which have a nonionic functional group containing an alkylene glycol unit, an alkylene glycol monoalkyl ether unit, or the like. The number of carbon atoms of the alkylene group in the alkylene glycol unit may be, for example, 2 to 8, and it is preferably 2 to 4. Further, the number of repeating alkylene glycol units may be, for example, 1 to 20, and it is preferably 2 to 10. The nitrogen-containing compounds, the sulfur-containing compounds, and the oxygen-containing compounds, which constitute the nonionic surface modifier, may contain an amino group, a thiol group, and a hydroxy group, respectively. Specific examples of the nonionic surface modifier include methoxytriethyleneoxy ethanethiol and methoxyhexaethyleneoxy ethanethiol.

Examples of the nitrogen-containing compound containing a hydrocarbon group having 4 to 20 carbon atoms include amines and amides. Examples of the sulfur-containing compound containing a hydrocarbon group having 4 to 20 carbon atoms include thiols. Examples of the oxygen-containing compound containing a hydrocarbon group having 4 to 20 carbon atoms include carboxylic acids, alcohols, ethers, aldehydes, and ketones. Examples of the phosphorus-containing compound containing a hydrocarbon group having 4 to 20 carbon atoms include trialkyl phosphines, triaryl phosphines, trialkyl phosphine oxides, and triaryl phosphine oxides.

Examples of the halide containing at least one selected from the group consisting of Group 2 elements, Group 12 elements, and Group 13 elements include magnesium chloride, calcium chloride, zinc chloride, cadmium chloride, aluminum chloride, and gallium chloride.

The quantum dots contained in the wavelength conversion layer may contain at least one selected from the group consisting of first quantum dots having a peak emission wavelength in a wavelength range of 475 nm to 560 nm and second quantum dots having a peak emission wavelength in a wavelength range of 600 nm to 680 nm. The quantum dots may contain at least one kind of the first quantum dots and at least one kind of the second quantum dots. The first quantum dots may contain at least one selected from the group consisting of, for example, perovskite quantum dots, indium phosphide quantum dots, and the chalcopyrite quantum dots of the first aspect. Preferably, the first quantum dots may contain at least one selected from the group consisting of perovskite quantum dots and the chalcopyrite quantum dots of the first aspect. Further, the second quantum dots may contain at least one selected from the group consisting of, for example, perovskite quantum dots, the chalcopyrite quantum dots of the second aspect, and indium phosphide quantum dots. Preferably, the second quantum dots may contain at least one selected from the group consisting of the chalcopyrite quantum dots of the second aspect and indium phosphide quantum dots. When the wavelength conversion layer contains the first quantum dots and the second quantum dots, irradiation of the wavelength conversion layer with, for example, a blue light having a wavelength of 420 nm to 460 nm causes the first quantum dots and the second quantum dots to emit a green light and a red light, respectively. As a result, the green light and the red light that are emitted from the first quantum dots and the second quantum dots are mixed with the blue light passing through the wavelength conversion layer, whereby a white light is obtained.

The wavelength conversion layer constituting the laminate may be provided in a single layer, or two or more layers. For example, when there are two wavelength conversion layers, one of the wavelength conversion layers may contain the first quantum dots, while the other wavelength conversion layer may contain the second quantum dots. The wavelength conversion layer may contain, for example, chalcopyrite quantum dots emitting a green light and chalcopyrite quantum dots emitting a red light. The wavelength conversion layer may contain chalcopyrite quantum dots emitting a green light and indium phosphide quantum dots emitting a red light. The wavelength conversion layer may contain perovskite quantum dots emitting a green light and indium phosphide quantum dots emitting a red light. The wavelength conversion layer may contain perovskite quantum dots emitting a green light and chalcopyrite quantum dots emitting a red light. Alternatively, the wavelength conversion layer may include, for example, a layer that contains chalcopyrite quantum dots emitting a green light, and a layer that contains chalcopyrite quantum dots emitting a red light. The wavelength conversion layer may include a layer that contains chalcopyrite quantum dots emitting a green light, and a layer that contains indium phosphide quantum dots emitting a red light. The wavelength conversion layer may include a layer that contains perovskite quantum dots emitting a green light, and a layer that contains indium phosphide quantum dots emitting a red light. The wavelength conversion layer may include a layer that contains perovskite quantum dots emitting a green light, and a layer that contains chalcopyrite quantum dots emitting a red light.

If necessary, in addition to the quantum dots, the wavelength conversion layer may contain at least one phosphor as a light emitting material other than the quantum dots. As the phosphor, for example, a garnet-based phosphor such as an aluminum-garnet phosphor can be used. Examples of the garnet-based phosphor include cerium-activated yttrium-aluminum-garnet phosphors, and cerium-activated lutetium-aluminum-garnet phosphors. In addition to the garnet-based phosphor, for example, a nitrogen-containing calcium aluminosilicate-based phosphor activated by europium and/or chromium, a silicate-based phosphor activated by europium, a β-SiAlON-based phosphor, a nitride-based phosphor such as a CASN-based or SCASN-based phosphor, a rare earth nitride-based phosphor such as a LnSi₃Ni-based or LnSiAlON-based phosphor, an oxynitride-based phosphor such as a BaSi₂O₂N₂:Eu-based or Ba₃Si₆O₁₂N₂:Eu-based phosphor, a sulfide-based phosphor such as a CaS-based, SrGa₂S₄-based, or ZnS-based phosphor, a chlorosilicate-based phosphor, a SrLiAl₃N₄:Eu phosphor, a SrMg₃SiN₄:Eu phosphor, and a manganese-activated fluoride complex phosphor such as a K₂SiF₆:Mn phosphor or a K₂(Si,Al)F₆:Mn phosphor (e.g., K₂Si_{0.99}Al_{0.01}F_{5.99}:Mn) can be used. In the present specification, plural elements listed separately with commas (,) in a formula representing the composition of a phosphor mean that at least one of the plural elements is contained in the composition. Further, in a formula representing the composition of a phosphor, the part preceding a colon (:) represents a host crystal, and the part following the colon (:) represents an activation element.

The wavelength conversion layer may contain, for example, chalcopyrite quantum dots emitting a green light and a manganese-activated fluoride complex phosphor emitting a red light, or a perovskite quantum dots emitting a green light and a manganese-activated fluoride complex phosphor emitting a red light. Alternatively, the wavelength conversion layer may include a layer that contains chalcopyrite quantum dots emitting a green light, and a layer that contains a manganese-activated fluoride complex phosphor emitting a red light. Further, the wavelength conversion layer may include a layer that contains perovskite quantum dots emitting a green light, and a layer that contains a manganese-activated fluoride complex phosphor emitting a red light.

The wavelength conversion layer may also contain a cured resin in addition to the quantum dots. The cured resin may be a cured product of the below-described photocurable composition. The content ratio of the quantum dots in the wavelength conversion layer may be, for example, 0.01% by mass to 1.0% by mass, preferably 0.05% by mass to 0.5% by mass, or 0.1% by mass to 0.5% by mass, with respect to a total amount of the cured resin. When the content ratio of the quantum dots is 0.01% by mass or more, a sufficient emission intensity tends to be obtained at the time of irradiating the wavelength conversion layer with light, whereas when the content ratio of the quantum dots is 1.0% by mass or less, aggregation of the quantum dots is inhibited, so that color unevenness tends to be reduced.

The photocurable composition forming the cured resin may contain, for example, a (meth)acrylic compound. This (meth)acrylic compound may be a monofunctional (meth)acrylic compound having a single (meth)acryloyl group in one molecule, or a polyfunctional (meth)acrylic compound having two or more (meth)acryloyl groups in one molecule. The (meth)acrylic compound may be used singly, or in combination of two or more kinds thereof, and a monofunctional (meth)acrylic compound and a polyfunctional (meth)acrylic compound may be used in combination. It is noted here that the term “(meth)acrylic compound” used herein encompasses an acrylic compound, a methacrylic compound, and a mixture thereof, and the same applies to similar notations.

Specific examples of the monofunctional (meth)acrylic compound include: (meth)acrylic acid; alkyl (meth)acrylates whose alkyl group has 1 to 18 carbon atoms, such as methyl (meth)acrylate, butyl (meth)acrylate, isobutyl (meth)acrylate, 2-ethylhexyl (meth)acrylate, isononyl (meth)acrylate, octyl (meth)acrylate, lauryl (meth)acrylate, and stearyl (meth)acrylate; (meth)acrylate compounds having an aromatic ring, such as benzyl (meth)acrylate and phenoxyethyl (meth)acrylate; aminoalkyl (meth)acrylates, such as N,N-dimethylaminoethyl (meth)acrylate; (meth)acrylate compounds having an alicyclic group, such as cyclohexyl (meth)acrylate, dicyclopentanyl (meth)acrylate, isobornyl (meth)acrylate, and methylene oxide-added cyclodecatriene (meth)acrylate; (meth)acrylate compounds having a heterocyclic group, such as (meth)acryloylmorpholine; fluorinated alkyl (meth)acrylates, such as heptadecafluorodecyl (meth)acrylate; (meth)acrylate compounds having a hydroxy group, such as 2-hydroxyethyl (meth)acrylate, 3-hydroxypropyl (meth)acrylate, and 4-hydroxybutyl (meth)acrylate; (meth)acrylate compounds having an isocyanate group, such as 2-(2-(meth)acryloyloxyethyloxy)ethyl isocyanate and 2-(meth)acryloyloxyethyl isocyanate; and (meth)acrylamide compounds, such as (meth)acrylamide, N,N-dimethyl (meth)acrylamide, N-isopropyl (meth)acrylamide, N,N-dimethylaminopropyl (meth)acrylamide, N,N-diethyl (meth)acrylamide, and 2-hydroxyethyl (meth)acrylamide.

From the standpoint of the heat resistance and the moist heat resistance of the cured product, the polyfunctional (meth)acrylic compound is preferably a compound having two to four (meth)acryloyl groups in the molecule, more preferably a compound having three (meth)acryloyl groups in the molecule.

Specific examples of the polyfunctional (meth)acrylic compound include: alkylene glycol di(meth)acrylates, such as 1,4-butanediol di(meth)acrylate, 1,6-hexanediol di(meth)acrylate, and 1,9-nonanediol di(meth)acrylate; tri(meth)acrylate compounds, such as trimethylolpropane tri(meth)acrylate and tris(2-hydroxyethyl)isocyanurate tri(meth)acrylate; and tetra(meth)acrylate compounds, such as trimethylolpropane tetra(meth)acrylate and pentaerythritol tetra(meth)acrylate.

From the standpoint of further improving the heat resistance and the moist heat resistance of the cured product, the (meth)acrylic compound may contain a monofunctional (meth)acrylate compound having an alicyclic group, or may contain isobornyl (meth)acrylate, dicyclopentanyl (meth)acrylate, or the like. Preferably, the (meth)acrylic compound may contain isobornyl (meth)acrylate.

In the photocurable composition, the content ratio of the (meth)acrylic compound may be, for example, 10% by mass to 50% by mass, preferably 15% by mass to 45% by mass, or 20% by mass to 40% by mass, with respect to a total amount of the photocurable composition. When the content ratio of the (meth)acrylic compound is 10% by mass or more, the storage stability of the photocurable composition and the adhesion of the cured product tend to be further improved, whereas when the content ratio of the (meth)acrylic compound is 50% by mass or less, the heat resistance and the moist heat resistance of the cured product tend to be further improved.

The photocurable composition may contain, for example, a (meth)allyl compound. The (meth)allyl compound may be a monofunctional (meth)allyl compound having a single (meth)allyl group in one molecule, or a polyfunctional (meth)allyl compound having two or more (meth)allyl groups in one molecule. The (meth)allyl compound may be used singly, or in combination of two or more kinds thereof, and a monofunctional (meth)allyl compound and a polyfunctional (meth)allyl compound may be used in combination. From the standpoint of further improving the adhesion of the cured product, the (meth)allyl compound preferably contains a polyfunctional (meth)allyl compound. A ratio of the polyfunctional (meth)allyl compound with respect to a total amount of the (meth)allyl compound may be, for example, 80% by mass or more, preferably 90% by mass or more, or 100% by mass.

Specific examples of the monofunctional (meth)allyl compound include (meth)allyl acetate, (meth)allyl propionate, (meth)allyl benzoate, (meth)allylphenyl acetate, (meth)allyl phenoxyacetate, (meth)allyl methyl ether, and (meth)allyl glycidyl ether.

From the standpoint of the heat resistance and the moist heat resistance of the cured product, the polyfunctional (meth)allyl compound is preferably a compound having two to four (meth)allyl groups in the molecule, more preferably a compound having three (meth)allyl groups in the molecule.

Specific examples of the polyfunctional (meth)allyl compound include di(meth)allyl cyclohexanedicarboxylate, di(meth)allyl maleate, di(meth)allyl adipate, di(meth)allyl phthalate, di(meth)allyl isophthalate, di(meth)allyl terephthalate, glycerin di(meth)allyl ether, trimethylolpropane di(meth)allyl ether, pentaerythritol di(meth)allyl ether, 1,3-di(meth)allyl-5-glycidyl isocyanurate, tri(meth)allyl cyanurate, tri(meth)allyl isocyanurate, tri(meth)allyl trimellitate, tetra(meth)allyl pyromellitate, 1,3,4,6-tetra (meth)allyl glycoluril, 1,3,4,6-tetra(meth)allyl-3a-methyl glycoluril, and 1,3,4,6-tetra(meth)allyl-3a,6a-dimethyl glycoluril. Thereamong, from the standpoint of the heat resistance and the moist heat resistance of the cured product, the polyfunctional (meth)allyl compound preferably contains at least one selected from the group consisting of tri(meth)allyl cyanurate, tri(meth)allyl isocyanurate, di(meth)allyl phthalate, di(meth)allyl isophthalate, di(meth)allyl terephthalate, and di(meth)allyl cyclohexanedicarboxylate, more preferably is tri(meth)allyl isocyanurate.

In the curable composition, the content ratio of the (meth)allyl compound may be, for example, 1% by mass to 30% by mass, preferably 5% by mass to 20% by mass, or 10% by mass to 15% by mass, with respect to a total amount of the curable composition. When the content ratio of the (meth)allyl compound is 1% by mass or more, the heat resistance and the moist heat resistance of the cured product tend to be further improved, whereas when the content ratio of the (meth)allyl compound is 30% by mass or less, the adhesion of the cured product tend to be further improved.

The photocurable composition preferably contains an alkyleneoxy group-containing compound having an alkyleneoxy group and a polymerizable reactive group. This tends to make the preparation of a high-viscosity curable composition easier and, at the time of preparing the curable composition that is an emulsion of a resin component and a dispersoid by stirring a mixture of these components, unification of the dispersoid caused by aggregation tends to be inhibited. As a result, a high dispersibility of the dispersoid is maintained, so that the wavelength conversion member tends to have excellent emission intensity.

The alkyleneoxy group-containing compound preferably has an ester group. By this, the dispersibility of the dispersoid such as modified silicone tends to be improved. The alkyleneoxy group-containing compound may have one or more ester groups, and preferably has two or more ester groups.

The alkyleneoxy group-containing compound preferably has two or more polymerizable reactive groups, and more preferably has two polymerizable reactive groups. When the alkyleneoxy group-containing compound has two or more polymerizable reactive groups, the adhesion, the heat resistance, and the moist heat resistance of the cured product tend to be further improved. Examples of the polymerizable reactive groups include functional groups having an ethylenic double bond, more specifically a (meth)acryloyl group.

From the standpoint of increasing the viscosity of the alkyleneoxy group-containing compound and thereby making it easier to prepare a high-viscosity curable composition, the alkyleneoxy group is preferably an alkyleneoxy group having 2 or more carbon atoms, more preferably an alkyleneoxy group having 2 or 3 carbon atoms, still more preferably an alkyleneoxy group having 2 carbon atoms. The alkyleneoxy group-containing compound may have a single kind of alkyleneoxy group, or two or more kinds of alkyleneoxy groups.

The alkyleneoxy group-containing compound may be a polyalkyleneoxy group-containing compound that has a polyalkyleneoxy group containing plural alkyleneoxy groups.

The alkyleneoxy group-containing compound may have 2 to 30 alkyleneoxy groups, preferably 2 to 20, 3 to 10, or 3 to 5 alkyleneoxy groups.

The alkyleneoxy group-containing compound preferably has a bisphenol structure. By this, excellent moist heat resistance tends to be obtained. Examples of the bisphenol structure include a bisphenol A structure and a bisphenol F structure, between which a bisphenol A structure is preferred.

Specific examples of the alkyleneoxy group-containing compound include: alkoxyalkyl (meth)acrylates, such as butoxyethyl (meth)acrylate; polyalkylene glycol monoalkyl ether (meth)acrylates, such as diethylene glycol monoethyl ether (meth)acrylate, triethylene glycol monobutyl ether (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol monomethyl ether (meth)acrylate, dipropylene glycol monomethyl ether (meth)acrylate, heptapropylene glycol monomethyl ether (meth)acrylate, and tetraethylene glycol monoethyl ether (meth)acrylate; polyalkylene glycol monoaryl ether (meth)acrylates, such as hexaethylene glycol monophenyl ether (meth)acrylate; (meth)acrylate compounds having a heterocycle, such as tetrahydrofurfuryl (meth)acrylate; (meth)acrylate compounds having a hydroxy group, such as triethylene glycol mono(meth)acrylate, tetraethylene glycol mono(meth)acrylate, hexaethylene glycol mono(meth)acrylate, and octapropylene glycol mono(meth)acrylate; (meth)acrylate compounds having a glycidyl group, such as glycidyl (meth)acrylate; polyalkylene glycol di(meth)acrylates, such as polyethylene glycol di(meth)acrylate and polypropylene glycol di(meth)acrylate; tri(meth)acrylate compounds, such as ethylene oxide-added trimethylolpropane tri(meth)acrylate; tetra(meth)acrylate compounds, such as ethylene oxide-added pentaerythritol tetra(meth)acrylate; and bisphenol-type di(meth)acrylate compounds, such as ethoxylated bisphenol A di(meth)acrylate, propoxylated bisphenol A di(meth)acrylate, and propoxylated ethoxylated bisphenol A (meth)acrylate. Thereamong, as the alkyleneoxy group-containing compound, ethoxylated bisphenol A di(meth)acrylate, propoxylated bisphenol A di(meth)acrylate, and propoxylated ethoxylated bisphenol A di(meth)acrylate are preferred, and ethoxylated bisphenol A di(meth)acrylate is more preferred. These alkyleneoxy group-containing compounds may be used singly, or in combination of two or more kinds thereof.

When the photocurable composition contains an alkyleneoxy group-containing compound, the content ratio of the alkyleneoxy group-containing compound in the photocurable composition may be, for example, 0.5% by mass to 10% by mass, preferably 1% by mass to 8% by mass, or 1.5% by mass to 5% by mass, with respect to a total amount of the photocurable composition. When the content ratio of the alkyleneoxy group-containing compound is 0.5% by mass or more, the viscosity of the photocurable composition tends to be increased, whereas when the content ratio of the alkyleneoxy group-containing compound is 10% by mass or less, the viscosity of the photocurable composition is not excessively increased, so that excellent production efficiency of the wavelength conversion member tends to be obtained.

The photocurable composition may contain at least one photopolymerization initiator. Examples of the photopolymerization initiator include compounds that generate radicals when irradiated with an active energy ray such as an ultraviolet ray.

Specific examples of the photopolymerization initiator include: aromatic ketone compounds, such as benzophenone, N,N′-tetraalkyl-4,4′-diaminobenzophenone, 2-benzyl-2-dimethylamino-1-(4-morpholinophenyl)-butan-1-one, 2-methyl-1-[4-(methylthio)phenyl]-2-morpholino-propan-1-one, 4,4′-bis(dimethylamino)benzophenone (also referred to as “Michler's ketone”), 4,4′-bis(diethylamino)benzophenone, 4-methoxy-4′-dimethylaminobenzophenone, 1-hydroxycyclohexyl phenyl ketone, 1-(4-isopropylphenyl)-2-hydroxy-2-methylpropan-1-one, 1-(4-(2-hydroxyethoxy)-phenyl)-2-hydroxy-2-methyl-1-propan-1-one, and 2-hydroxy-2-methyl-1-phenylpropan-1-one; quinone compounds, such as alkyl anthraquinone and phenanthrenequinone; benzoin compounds, such as benzoin and alkylbenzoin; benzoin ether compounds, such as benzoin alkyl ether and benzoin phenyl ether; benzyl derivatives, such as benzyl dimethyl ketal; 2,4,5-triaryl imidazole dimers, such as 2-(o-chlorophenyl)-4,5-diphenyl imidazole dimer, 2-(o-chlorophenyl)-4,5-di(m-methoxyphenyl)imidazole dimer, 2-(o-fluorophenyl)-4,5-diphenyl imidazole dimer, 2-(o-methoxyphenyl)-4,5-diphenyl imidazole dimer, 2,4-di(p-methoxyphenyl)-5-phenyl imidazole dimer, and 2-(2,4-dimethoxyphenyl)-4,5-diphenyl imidazole dimer; acridine derivatives, such as 9-phenyl acridine and 1,7-(9,9′-acridinyl)heptane; oxime ester compounds, such as 1,2-octanedione 1-[4-(phenylthio)-2-(0-benzoyloxime)] and ethanone 1-[9-ethyl-6-(2-methylbenzoyl)-9H-carbazol-3-yl]-1-(0-acetyloxime); coumarin compounds, such as 7-diethylamino-4-methyl coumarin; thioxanthone compounds, such as 2,4-diethyl thioxanthone; and acylphosphine oxide compounds, such as 2,4,6-trimethylbenzoyldiphenyl phosphine oxide and 2,4,6-trimethylbenzoylphenyl ethoxyphosphine oxide. These photopolymerization initiators may be used singly, or in combination of two or more kinds thereof.

From the standpoint of curability, the photopolymerization initiator is preferably at least one selected from the group consisting of acylphosphine oxide compounds, aromatic ketone compounds, and oxime ester compounds, more preferably at least one selected from the group consisting of acylphosphine oxide compounds and aromatic ketone compounds, still more preferably an acylphosphine oxide compound.

In the photocurable composition, the content ratio of the photopolymerization initiator may be, for example, 0.1% by mass to 5% by mass, preferably 0.1% by mass to 3% by mass, or 0.5% by mass to 1.5% by mass, with respect to a total amount of the photocurable composition. When the content ratio of the photopolymerization initiator is 0.1% by mass or more, the photocurable composition tends to have sufficient sensitivity, whereas when the content ratio of the photopolymerization initiator is 5% by mass or less, effects on the hue of the photocurable composition and deterioration in the storage stability of the photocurable composition tend to be inhibited.

The curable composition may also contain a liquid medium. This liquid medium refers to a medium that is in a liquid state at room temperature (25° C.). Examples of the liquid medium include ketone solvents, ether solvents, carbonate solvents, ester solvents, aprotic polar solvents, alcohol solvents, glycol monoether solvents, aromatic hydrocarbon solvents, terpene solvents, saturated aliphatic monocarboxylic acids, and unsaturated aliphatic monocarboxylic acids. The curable composition may contain any of these liquid media singly, or two or more kinds of these liquid media in combination.

When the photocurable composition contains a liquid medium, the content ratio of the liquid medium in the photocurable composition may be, for example, 1% by mass to 10% by mass, preferably 4% by mass to 10% by mass, or 4% by mass to 7% by mass, with respect to a total amount of the photocurable composition.

The photocurable composition, if necessary, may contain other components, such as a polymerization inhibitor, a silane coupling agent, a surfactant, and adhesion promoter, and an antioxidant. The photocurable composition may contain each of these other components singly, or two or more kinds of each of these other components in combination.

The photocurable composition may further contain quantum dots. The photocurable composition containing quantum dots can be prepared by, for example, mixing the quantum dots, a (meth)acrylic compound, an alkyleneoxy group-containing compound, a photopolymerization initiator and, if necessary, the above-described components by a conventional method. The quantum dots are preferably mixed in a state of, for example, a quantum dot dispersion in which the quantum dots are dispersed in a monofunctional (meth)acrylate compound having an alicyclic group and a liquid medium.

The wavelength conversion layer can be formed by curing the photocurable composition containing quantum dots. Specifically, the wavelength conversion layer containing quantum dots and a cured resin can be formed by, for example, applying the photocurable composition containing the quantum dots between two barrier layers and subsequently curing the photocurable composition by photoirradiation.

The wavelength and the irradiation dose of the light to be irradiated at the time of forming the wavelength conversion layer can be set as appropriate in accordance with the formulation of the photocurable composition. In one aspect, an ultraviolet light having a wavelength of 280 nm to 400 nm is irradiated at an irradiation dose of 100 mJ/cm² to 5,000 mJ/cm². Examples of an ultraviolet light source include a low-pressure mercury lamp, a medium-pressure mercury lamp, a high-pressure mercury lamp, an ultrahigh-pressure mercury lamp, a carbon arc lamp, a metal halide lamp, a xenon lamp, a chemical lamp, a black light lamp, a microwave-excited mercury lamp, and an ultraviolet light emitting diode (UV-LED).

The wavelength conversion layer may be formed in the form of a film that has two main surfaces facing each other, and an end surface surrounding the periphery of the main surfaces. When the wavelength conversion layer is in the form of a film, an average thickness of the wavelength conversion layer, which corresponds to the height of the end surface, may be, for example, 30 μm to 200 μm, preferably 30 μm to 150 μm, or 80 μm to 120 μm. When the average thickness is 30 μm or more, the wavelength conversion efficiency tends to be further improved, whereas when the average thickness is 200 μm or less, a backlight unit tends to be further reduced in thickness by applying the wavelength conversion layer to the backlight unit. The average thickness of a film-form cured product can be determined as, for example, an arithmetic mean value of the thickness measured at arbitrary three spots using a reflection spectroscopic film thickness meter or the like.

The laminate is configured such that barrier layers are each laminated on one of the main surfaces of the wavelength conversion layer and on the other main surface. As the barrier layers, from the standpoint of inhibiting a reduction in the emission efficiency of the quantum dots, for example, barrier films having an inorganic layer can be used.

The barrier layers may have an average thickness of, for example, 20 μm to 150 μm, preferably 20 μm to 120 μm, or 25 μm to 100 μm. When the average thickness is 20 μm or more, functions such as barrier property tend to be obtained sufficiently, whereas when the average thickness is 150 μm or less, a reduction in the light transmission tends to be inhibited. The average thickness of the barrier layers can be determined in the same manner as that of the wavelength conversion layer in the form of a film.

The barrier layers preferably have a barrier property against oxygen. The barrier layers may have an oxygen permeability of, for example, 0.5 mL/(m²·24 h·atm) or less, preferably 0.3 mL/(m²·24 h·atm) or less, or 0.1 mL/(m²·24 h·atm) or less. The oxygen permeability of the barrier layers can be measured at a temperature of 23° C. and a relative humidity of 65% using an oxygen permeability measuring device (e.g., OX-TRAN manufactured by MOCON Inc.).

The barrier films having an inorganic layer that constitute the barrier layers may each include, for example, a substrate film, and an inorganic layer arranged on at least one main surface of the substrate film. Further, the barrier layers may each be, for example, a laminated film that includes two substrate films, and an inorganic layer arranged between the two substrate films. Examples of a material constituting the substrate film include thermoplastic resins, such as polyester (e.g., polyethylene terephthalate and polyethylene naphthalate), cellulose triacetate, cellulose diacetate, cellulose acetate butyrate, polyamide, polyimide, polyether sulfone, polysulfone, polypropylene, polymethyl pentene, polyvinyl chloride, polyvinyl acetal, polyether ketone, methyl polymethacrylate, polycarbonate, and polyurethane. The material constituting the substrate film is preferably, for example, polyester or cellulose triacetate.

The substrate film may have an average thickness of, for example, 10 μm to 150 μm, preferably 20 μm to 125 μm. When the average thickness of the substrate film is 10 μm or more, the generation of wrinkles and the occurrence of breakage during assembling and handling of the wavelength conversion member are effectively inhibited. Meanwhile, when the average thickness is 150 μm or less, the substrate film can contribute to a weight reduction and a thickness reduction of an image display device.

The substrate film may be composed of a single film, or may be a laminated film composed of plural films. Such a laminated film, depending on the intended use thereof, may be composed of plural layers that are formed of films made of the same constitutent raw materials, or may be composed of plural layers that are formed of films made of different constituent raw materials.

The inorganic layer may be a film formed of an inorganic compound, such as an oxide, a nitride, an oxynitride, or a carbide. Specific examples of the inorganic compound include: metal oxides, such as aluminum oxide, magnesium oxide, tantalum oxide, zirconium oxide, titanium oxide, and indium tin oxide (ITO); metal nitrides, such as aluminum nitride; metal carbides, such as aluminum carbide; oxides of silicon, such as silicon oxide, silicon oxynitride, silicon oxycarbide, and silicon oxynitrocarbide; nitrides of silicon, such as silicon nitride and silicon nitrocarbide; carbides of silicon, such as silicon carbide; and hydrides of these inorganic compounds. The inorganic layer may be composed of a single kind of inorganic compound, or two or more kinds of inorganic compounds.

The inorganic layer may have an average thickness of, for example, 10 nm to 200 nm, preferably 10 nm to 100 nm, or 15 nm to 75 nm.

The inorganic layer may be formed by any known method in accordance with its constituent materials. Specific examples of the known method include: plasma CVD methods, such as CCP-CVD and ICP-CVD; sputtering methods, such as magnetron sputtering and reactive sputtering; vacuum deposition methods; and vapor deposition methods.

The barrier layers constituting the laminate may each have a first modification part on at least a portion of their end surfaces. The first modification part may have, on its surface, at least one oxygen-containing functional group (hereinafter, also simply referred to as “functional group”) selected from the group consisting of a carboxy group, a hydroxy group, and a carbonyl group. The presence of a functional group on the surface of the first modification part can be identified by, for example, measuring an infrared absorption spectrum on the surface of the first modification part. The infrared absorption spectrum can be measured by, for example, an attenuated total reflection (ATR) method using a Fourier transform infrared spectrophotometer (e.g., manufactured by Thermo Fisher Scientific K.K.). Specifically, the presence of carbonyl group can be identified by detecting a peak attributed to CO stretching vibration (e.g., wavenumber=1,725 cm⁻¹). Further, the presence of hydroxy group can be identified by detecting a peak attributed to OH stretching vibration (e.g., wavenumber=3,300 cm⁻¹). The first modification part can be formed by, for example, applying an energy to the respective barrier layers.

The content of a functional group in the first modification part can be evaluated by, for example, measuring an infrared absorption spectrum on the surface of the first modification part. Specifically, the content of each functional group can be evaluated by, for example, calculating a ratio (I¹_{CO}/I¹_{CH}) of the intensity I¹_{CO} of a peak attributed to CO stretching vibration and a ratio (I¹_{OH}/I¹_{CH}) of the intensity I¹_{OH} of a peak attributed to OH stretching vibration, based on the intensity I¹_{CH} of a peak attributed to CH stretching vibration (e.g., wavenumber=2,957 cm⁻¹). The ratio (I¹_{CO}/I¹_{CH}) on the surface of the first modification part may be, for example, 0.1 to 30, preferably 0.5 or higher, 1 or higher, 5 or higher, 7 or higher, or 9 or higher, but preferably 20 or lower, 15 or lower, 14 or lower, 12 or lower, or 11 or lower. Further, the ratio (I¹_{OH}/I¹_{CH}) on the surface of the first modification part may be, for example, 0.1 to 10, preferably 0.2 or higher, 0.4 or higher, 0.6 or higher, or 0.8 or higher, but preferably 5 or lower, 4 or lower, 2 or lower, 1.5 or lower, or 1.2 or lower. When the intensity ratio of the peak attributed to CO stretching vibration and that of the peak attributed to OH stretching vibration on the surface of the first modification part is in the above-described respective numerical ranges, the moisture components contained in the ambient air and the like are likely to bind with CO groups and OH groups on the surface of the first modification part. As a result, the intrusion of the moisture components contained in the ambient air and the like into the wavelength conversion member can be effectively inhibited.

The barrier layers have the first modification part on their end surfaces, and a region other than the first modification part is a non-modification part that is not modified. The non-modification part may be, for example, a region where an energy for the formation of the first modification part is not applied. In the non-modification part that is an unmodified region of each barrier layer (hereinafter, also referred to as “first non-modification part”), the content of a functional group may be less than the content of the functional group in the first modification part. In other words, a ratio of the content of a functional group in the first modification part with respect to the content of the functional group in the non-modification part may be higher than 1. The non-modification part may be a region that is away from the end surface of each barrier layer by a prescribed distance in the direction parallel to the main surface of the barrier layer, for example, a region that is away from the end surface by 5 mm or more, preferably 10 mm or more, or 20 mm or more. Further, the non-modification part may be the end surface of each barrier layer prior to the formation of a singulated laminate using a laser beam in the below-described production method. It is noted here that the first modification part may be a region within a distance of 10 μm, preferably 9 μm from the end surface of each barrier layer in the direction parallel to the main surface of the barrier layer.

The content of a functional group in the first modification part and that in the first non-modification part can each be evaluated by measuring an infrared absorption spectrum in the above-described manner. Accordingly, in the thus measured infrared absorption spectra, a ratio of the intensity of a peak corresponding to the hydroxy group in the first modification part with respect to the intensity of a peak corresponding to the hydroxy group in the first non-modification part may be higher than 1, preferably 1.03 or higher, 1.05 or higher, or 1.1 or higher, but 20 or lower, 10 or lower, 5 or lower, 2 or lower, or 1.2 or lower. Further, in the infrared absorption spectra, a ratio of the intensity of a peak corresponding to the carbonyl group in the first modification part with respect to the intensity of a peak corresponding to the carbonyl group in the first non-modification part may be higher than 1, preferably 1.1 or higher, 1.2 or higher, or 1.25 or higher, but 20 or lower, 10 or lower, 5 or lower, 2 or lower, or 1.5 or lower. It is noted here that, as described above, the intensity of the peak corresponding to the hydroxy group may be a ratio of the intensity of a peak attributed to OH stretching vibration based on the intensity of a peak attributed to CH stretching vibration, and the intensity of the peak corresponding to the carbonyl group may be a ratio of the intensity of a peak attributed to CO stretching vibration based on the intensity of a peak attributed to CH stretching vibration.

The first modification part may be, for example, a thermally denatured product of the thermoplastic resin constituting the barrier layers. It is believed that, by forming the end surface of the laminate using a laser beam as in the below-described method of producing a wavelength conversion member, the thermoplastic resin constituting the barrier layers is thermally denatured and the first modification part is thereby formed. The first modification part may be formed on at least a portion of the end surface of each barrier layer, or may be formed on the entirety of the end surface of each barrier layer.

The wavelength conversion layer constituting the laminate may have a second modification part on at least a portion of its end surface. The second modification part may have, on its surface, at least one oxygen-containing functional group (hereinafter, also simply referred to as “functional group”) selected from the group consisting of a carboxy group, a hydroxy group, and a carbonyl group. The presence of a functional group on the surface of the second modification part can be identified by, for example, measuring an infrared absorption spectrum on the surface of the second modification part in the same manner as on the surface of the first modification part. The second modification part can be formed by, for example, applying an energy to the wavelength conversion layer.

The content of a functional group in the second modification part can be evaluated by, for example, measuring an infrared absorption spectrum on the surface of the second modification part. Specifically, the content of each functional group can be evaluated by, for example, calculating a ratio (I²_{CO}/I²_{CH}) of the intensity I²_{CO} of a peak attributed to CO stretching vibration and a ratio (I²_{OH}/I²_{CH}) of the intensity I²_{OH} of a peak attributed to OH stretching vibration, based on the intensity I²_{CH} of a peak attributed to CH stretching vibration (e.g., wavenumber=2,957 cm⁻¹). The ratio (I²_{CO}/I²_{CH}) on the surface of the second modification part may be, for example, 0.1 to 30, preferably 0.2 or higher, 0.4 or higher, 0.8 or higher, 1 or higher, or 1.2 or higher, but preferably 15 or lower, 10 or lower, 6 or lower, 4 or lower, or 2 or lower. Further, the ratio (I²_{OH}/I²_{CH}) on the surface of the second modification part may be, for example, 0.1 to 10, preferably 0.2 or higher, 0.3 or higher, but preferably 5 or lower, 4 or lower, 3 or lower, 2 or lower, 1 or lower, 0.8 or lower, or 0.6 or lower. When the intensity ratio of the peak attributed to CO stretching vibration and that of the peak attributed to OH stretching vibration on the surface of the second modification part is in the above-described respective numerical ranges, the moisture components contained in the ambient air and the like are likely to bind with CO groups and OH groups on the surface of the second modification part. It is believed that, as a result, the intrusion of the moisture components contained in the ambient air and the like into the wavelength conversion member can be effectively inhibited.

The wavelength conversion layer has the second modification part on its end surface, and a region other than the second modification part is a non-modification part that is not modified. The non-modification part may be, for example, a region where an energy for the formation of the second modification part is not applied. In the non-modification part that is an unmodified region of the wavelength conversion layer (hereinafter, also referred to as “second non-modification part”), the content of a functional group may be less than the content of the functional group in the second modification part. In other words, a ratio of the content of a functional group in the second modification part with respect to the content of the functional group in the non-modification part may be higher than 1. The second non-modification part may be a region that is away from the end surface of the wavelength conversion layer by a prescribed distance in the direction parallel to the main surface of the wavelength conversion layer, for example, a region that is away from the end surface by 5 mm or more, preferably 10 mm or more, or 20 mm or more. Further, the non-modification part may be the end surface of the wavelength conversion layer prior to the formation of a singulated laminate using a laser beam in the below-described production method. It is noted here that the second modification part may be a region within a distance of 10 μm, preferably 9 μm from the end surface of the wavelength conversion layer in the direction parallel to the main surface of the wavelength conversion layer.

The content of a functional group in the second modification part and that in the second non-modification part can each be evaluated by measuring an infrared absorption spectrum in the above-described manner. Accordingly, in the thus obtained infrared absorption spectra, a ratio of the intensity of a peak corresponding to the hydroxy group in the second modification part with respect to the intensity of a peak corresponding to the hydroxy group in the second non-modification part may be higher than 1, preferably 1.2 or higher, 2 or higher, or 2.4 or higher, 2.6 or higher, 2.8 or higher, or 3 or higher, but 8 or lower, 7 or lower, 6 or lower, 5 or lower, or 4 or lower. Further, in the infrared absorption spectra, a ratio of the intensity of a peak corresponding to the carbonyl group in the second modification part with respect to the intensity of a peak corresponding to the carbonyl group in the second non-modification part may be higher than 1, preferably 1.2 or higher, 1.6 or higher, 2 or higher, or 2.4 or higher, but 8 or lower, 7 or lower, 6 or lower, 5 or lower, or 4 or lower. It is noted here that, as described above, the intensity of the peak corresponding to the hydroxy group may be a ratio of the intensity of a peak attributed to OH stretching vibration based on the intensity of a peak attributed to CH stretching vibration, and the intensity of the peak corresponding to the carbonyl group may be a ratio of the intensity of a peak attributed to CO stretching vibration based on the intensity of a peak attributed to CH stretching vibration.

The second modification part may be, for example, a thermally denatured product of the cured resin constituting the wavelength conversion layer. It is believed that, by forming the end surface of the laminate using a laser beam as in the below-described method of producing a wavelength conversion member, the cured resin constituting the wavelength conversion layer is thermally denatured and the second modification part is thereby formed. The second modification part may be formed on at least a portion of the end surface of the wavelength conversion layer, or may be formed on the entirety of the end surface of the wavelength conversion layer.

In the laminate, the second modification part may be at least partially exposed on the end surface of the laminate. The second modification part exposed on the end surface of the laminate may have an average thickness of 10% to 80%, preferably 20% to 70%, or 20% to 60%, with respect to the average thickness of the wavelength conversion layer. It is noted here that the thickness of the second modification part means the height of the second modification part in the lamination direction of the laminate. The ratio of the average thickness of the second modification part exposed on the end surface of the laminate with respect to the average thickness of the wavelength conversion layer is determined by measuring the thickness of the exposed second modification part at arbitrary three spots, and calculating an arithmetic mean of values obtained by dividing the measured values by the average thickness of the wavelength conversion layer, in terms of percentage. In one aspect, the end surface of the laminate may be formed such that the first modification part, the second modification part, and the first modification part are laminated in this order.

Further, in one aspect, the first modification part may cover at least a portion of the boundary between each barrier layer and the wavelength conversion layer on the end surface of the laminate. When the first modification part covers the boundary between each barrier layer and the wavelength conversion layer, the wavelength conversion member can be configured such that discoloration from its end portion is more effectively inhibited. The length of the boundary covered by the first modification part may be 1% or more, preferably 10% or more, or 100%, with respect to a total length of the boundary on the end surface of the laminate.

When the first modification part covers the boundary between each barrier layer and the wavelength conversion layer, the first modification part may further cover a portion of the wavelength conversion layer. The portion of the wavelength conversion layer that is covered may be a portion of the second modification part, or an unmodified portion of the wavelength conversion layer. As for the coverage ratio of the portion of the wavelength conversion layer that is covered by the first modification part may be, for example, 5% to 50%, preferably 5% to 30%, or 5% to 10%, in terms of the ratio of the area of the portion of the wavelength conversion layer that is covered by the first modification part with respect to the area of the wavelength conversion layer that is calculated from the length of the end surface of the laminate and the average thickness of the wavelength conversion layer.

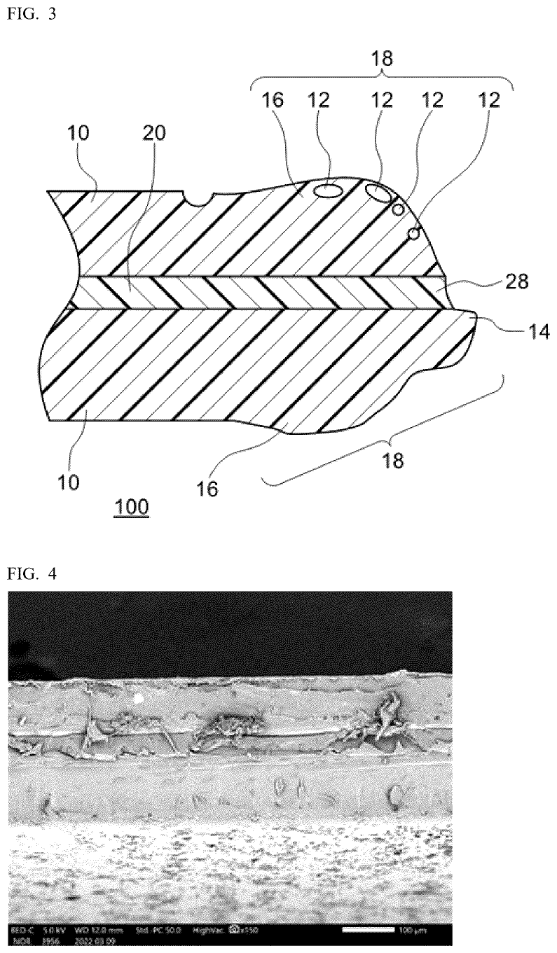

One aspect of an end portion of a wavelength conversion member including a laminate will now be described referring to the drawings. FIG. 3 is a schematic cross-sectional view that schematically illustrates one aspect of a cross-section of an end portion of a wavelength conversion member 100, which cross-section is parallel to the lamination direction. The wavelength conversion member 100 is constituted by: a wavelength conversion layer 20; and barrier layers 10 each arranged on two main surfaces of the wavelength conversion layer 20. In the end portion of the wavelength conversion member 100, a first modification part 18 is formed in an end portion of each barrier layer 10, and a second modification part 28 is formed in an end portion of the wavelength conversion layer 20. In the first modification part 18, for example, a thickened part 16 which is formed by an increase in the thickness of each barrier layer, and air bubble parts 12 which are formed by a gas generated due to laser beam irradiation are formed.

The thickened part 16 is configured such that the main surface of each barrier layer, which is on the opposite side of the wavelength conversion layer side, expands in the lamination direction. By the formation of the thickened part 16 in the end portion of the wavelength conversion member 100, the water vapor permeability to the side of the end portion can be further reduced. The end portion of the laminate has penetration pathways of moisture in the lamination direction and the direction perpendicular to the lamination direction, and is thus a region that is likely to be exposed to moisture; however, by the formation of the thickened part 16, the intrusion of moisture can be effectively inhibited.

Further, by the formation of the air bubble parts 12 in the first modification part 18, for example, even when a stress is applied to the end portion of the wavelength conversion member 100, delamination of the wavelength conversion layer 20 and the barrier layers 10 can be inhibited by a buffering action derived from the air bubble parts 12. A stress may be unintentionally applied to the end portion of the wavelength conversion member during, for example, transport of the wavelength conversion member, or integration of the wavelength conversion member into a backlight device or the like. Further, by the formation of the air bubble parts 12, a difference in refractive index is created in each barrier layer, as a result of which the light scattering property of the wavelength conversion member may be improved.

On the barrier layers in the end portion of the wavelength conversion member 100, a protruding part 14 which protrudes to the outer side than the wavelength conversion layer may be formed. The protruding part 14 may be formed as a part of the first modification part 18. By the formation of the protruding part in the end portion of the wavelength conversion member, for example, at the time of integrating the wavelength conversion member into a backlight device or the like, direct application of a stress to the wavelength conversion layer, which is caused by an interference between the wavelength conversion member and a casing or the like of the backlight device or the like, can be inhibited. As a result, delamination of the wavelength conversion layer and the barrier layers is inhibited, so that the intrusion of moisture and the like into the wavelength conversion layer can be more effectively inhibited. Further, at the time of arranging an end surface covering layer on the end surface of the laminate, the contact area between the end surface of the laminate and the end surface covering layer is increased, so that the adhesion of the end surface covering layer to the laminate is further improved.

The wavelength conversion member may further include an end surface covering layer that covers the end surface of the laminate. By providing the end surface covering layer, discoloration of the wavelength conversion member from its end portion can be more effectively inhibited. The end surface covering layer may be, for example, a member that is configured to contain an inorganic material and has a gas barrier property. The end surface covering layer may also be a member that inhibits the intrusion of moisture, oxygen, and the like from the end surface of the laminate. The end surface covering layer may be arranged to cover at least a portion of the end surface of the laminate, and may be preferably arranged to cover the whole end surface of the laminate over the entire circumference.

The end surface covering layer may include, for example, the film exemplified above as an inorganic layer, which is formed of an inorganic compound such as an oxide, a nitride, an oxynitride, or a carbide. Particularly, from the standpoint of gas barrier property and high refractive index, a silicon compound such as silicon oxide, silicon nitride, silicon oxynitride, or silicon carbide may be used. The end surface covering layer may be composed of a single kind of inorganic compound, or two or more kinds of inorganic compounds. Further, the end surface covering layer may include a cured resin layer that is formed of a resin composition containing at least one functional material selected from the group consisting of the below-described moisture removers (moisture scavengers), oxygen removers (oxygen scavengers), antioxidants, and the like. The resin composition may contain, for example, an epoxy resin as a matrix.

When the end surface covering layer includes a film formed of an inorganic compound, the average thickness of the film in the direction perpendicular to the end surface of the laminate may be, for example, 0.05 μm to 1 μm, preferably 0.05 μm to 0.9 μm, or 0.1 μm to 0.8 μm. When the end surface covering layer includes a cured resin layer, the average thickness of the cured resin layer may be, for example, 5 μm to 1,000 μm, preferably 200 μm to 800 μm, or 300 μm to 650 μm. The thickness of the end surface covering layer is, for example, the distance between the outermost end of the end surface covering layer and the end surface of the laminate when the laminate is viewed from above. When the end surface covering layer includes a cured resin layer, the cured resin layer may have a uniform thickness along the lamination direction of the wavelength conversion member, or may have an increasing or decreasing thickness toward one direction.

The end surface covering layer may be formed by any known method in accordance with its constituent materials. When the end surface covering layer includes a film formed of an inorganic compound, specifically, the film formed of an inorganic compound can be formed by a plasma CVD method such as CCP-CVD or ICP-CVD, a sputtering method such as magnetron sputtering or reactive sputtering, a vacuum deposition method, a vapor deposition method, or the like. Further, when the end surface covering layer includes a cured resin layer, the cured resin layer can be formed by applying a desired resin composition to the end surface of the laminate, and subsequently curing the resin composition.

FIG. 8 is a schematic cross-sectional view of a wavelength conversion member 110, which illustrates one example of the end surface covering layer. An end surface covering layer 30 illustrated in FIG. 8 is a cured resin layer that is formed of a resin composition containing an epoxy resin and at least one functional material selected from the group consisting of moisture removers (moisture scavengers), oxygen removers (oxygen scavengers), and antioxidants. In FIG. 8, the end surface covering layer 30 is provided on both sides of the opposing end surfaces of the wavelength conversion member 110. The end surface covering layer 30 may be provided on the entirety of the end surface surrounding the outer circumference of the wavelength conversion member 110. On the end surface of the wavelength conversion member 110, the end surface covering layer 30 is arranged across the two barrier layers 10 and the wavelength conversion layer 20, covering at least the boundary between the barrier layer 10 positioned above and the wavelength conversion layer 20, as well as the boundary between the barrier layer 10 positioned below and the wavelength conversion layer 20. By this, the intrusion of moisture and the like through the boundaries between the respective barrier layers 10 and the wavelength conversion layer 20 can be more effectively inhibited. In the height direction, the upper end of the end surface covering layer 30 is positioned higher than the boundary between the barrier layer 10 positioned above and the wavelength conversion layer 20. In the end surface covering layer 30 illustrated in FIG. 8, as indicated by opposing arrows, the upper end of the end surface covering layer 30 is positioned between the upper surface of the barrier layer 10 positioned above and the upper surface of the wavelength conversion layer 20, not reaching the upper surface of the barrier layer 10 positioned above. By offsetting the upper end of the end surface covering layer 30 from the upper surface of the barrier layer 10, the end surface covering layer 30 can be prevented from involuntarily creeping up to the upper surface of the barrier layer 10 at the time of arranging the end surface covering layer 30, so that a reduction in brightness can be inhibited in the upper surface end portion of the laminate. Further, the lower end of the end surface covering layer 30 is positioned in substantially the same plane as the lower surface of the barrier layer 10 positioned below. The end surface covering layer 30 has an inclined surface 32 that is inclined with respect to the upper surface of the barrier layer 10 positioned above. The inclined surface 32 may be a flat surface, or may include a curved surface. When the wavelength conversion member is provided with the end surface covering layer that covers the end surface of the laminate, the end surface of the laminate may be a surface that is formed by cutting by laser beam irradiation, or may be a surface that is not cut by laser beam irradiation. Preferably, the end surface of the laminate may be a surface that is formed by cutting by laser beam irradiation.

The wavelength conversion member, if necessary, may also include a laminate including other layers. Examples of the other layers include a hard coat layer, an optical compensation layer, a transparent conductive layer, an adhesion-imparting layer, and the below-described intermediate layer.

The laminate may include an intermediate layer that is arranged between the wavelength conversion layer and one barrier layer. As the intermediate layer, a member that exhibits good adhesion to both the wavelength conversion layer and the barrier layer may be selected. This enables to inhibit the intrusion of moisture and the like through, for example, the boundary between the intermediate layer and the wavelength conversion layer, and the boundary between the intermediate layer and the barrier layer. The intermediate layer may contain, as a matrix, for example, a cured resin having the same composition as the cured resin exemplified above in the description of the wavelength conversion layer.

The intermediate layer may further contain at least one functional material in addition to the cured resin. Examples of the functional material include moisture removers (moisture scavengers), oxygen removers (oxygen scavengers), and antioxidants, and the intermediate layer may contain at least one selected from the group consisting of these functional materials.

Examples of the moisture removers include: oxides of Group 2 elements, such as magnesium oxide and calcium oxide; hydrotalcites; aluminosilicates (e.g., zeolite); and silicon oxides (e.g., silica gel). The hydrotalcites may be compounds having a composition represented by the following Formula (3):

[M³₁₋ₓM⁴ₓ(OH)₂π^{x+}[Aⁿ⁻_{x/n}·mH₂Oπ^{x-} (3)

In Formula (3), M³ represents a divalent metal ion, such as Mg²⁺, Mn²⁺, Fe²⁺, Co²⁺, Ni²⁺, Cu²⁺, or Zn²⁺; M⁴ represents a trivalent metal ion, such as Fe³⁺, Cr³⁺, Co³⁺, or In³⁺; Aⁿ⁻ represents an n-valent anion, such as OH⁻, F⁻, Cl⁻, Br⁻, NO₃⁻, CO₃²⁻, SO₄²⁻, Fe(CN)₆³⁻, CH₃COO⁻, an oxalate ion, or a salicylate ion; x satisfies 0<x≤0.33; and m represents a positive number.

Examples of the oxygen removers include ceria-zirconia solid solution (CZ solid solution). Further, examples of the antioxidants include ascorbic acid, catechin, dibutylhydroxytoluene, tocopherol, and butylhydroxyanisole.

The content of the functional material in the intermediate layer may be, for example, 0.1 parts by mass to 20 parts by mass, preferably 0.1 parts by mass to 15 parts by mass, or 0.1 parts by mass to 2 parts by mass, with respect to 100 parts by mass of the cured resin. By setting the content of the functional group in the intermediate layer to be in the above-described range, a reduction in the emission efficiency of the wavelength conversion member caused by the functional material can be inhibited while inhibiting the intrusion of moisture contained in the ambient air and the like.

The intermediate layer may have a thickness of, for example, 10 μm to 100 μm, preferably 20 μm or more, or 30 μm or more, but preferably 70 μm or less, or 40 μm or less.

### Method of Producing Wavelength Conversion Member

A method of producing a wavelength conversion member may include: a first step of providing a laminated sheet that includes a wavelength conversion layer containing quantum dots, and two barrier layers each laminated on one of main surfaces of the wavelength conversion layer and on the other main surface; and a second step of cutting the laminated sheet by irradiation with a laser beam intersecting the main surfaces of the laminated sheet to obtain a singulated laminate. The irradiation with a laser beam in the second step may be performed at a laser beam frequency of 5 kHz to 30 kHz, a scanning speed of 50 mm/s to 100 mm/s, and a laser beam output of 3.4 W to 100 W.

By cutting and singulating the laminated sheet by the irradiation with a laser beam and thereby forming a laminate, discoloration from an end portion can be inhibited in the resulting wavelength conversion member including the laminate. This is believed to be because, for example, by cutting the laminated sheet by the irradiation with a laser beam, the first modification parts derived from the respective barrier layers and a second modification part derived from the wavelength conversion layer are formed on an end surface of the laminate.

In the first step, a laminated sheet, which includes a wavelength conversion layer containing quantum dots and two barrier layers each laminated on one of main surfaces of the wavelength conversion layer and on the other main surface, is provided. The laminated sheet can be produced, for example, in the following manner. A first composition layer is formed by applying the above-described photocurable composition to a surface of a film-form barrier layer (e.g., a barrier film) that is continuously transported. Examples of a method of applying the photocurable composition include a gravure coating method, a die coating method, a curtain coating method, an extrusion coating method, a rod coating method, and a roll coating method. Subsequently, another film-form barrier layer (e.g., a barrier film) is pasted onto the first composition layer. By this, a laminated sheet precursor in which the barrier layer, the first composition layer, and the barrier layer are laminated in this order is obtained. Thereafter, a light is irradiated from the side of one of the barrier layers to cure the first composition layer and form a wavelength conversion layer, whereby a laminated sheet in which the barrier layer, the wavelength conversion layer, and the barrier layer are laminated in this order is obtained. In this process, if necessary, a drying treatment, a heat treatment, and the like may be performed on the first composition layer prior to the irradiation of the light. It is noted here that the details of the wavelength conversion layer and the barrier layers that constitute the laminated sheet are as described above.

In the second step, the laminated sheet is cut by irradiation with a laser beam intersecting the main surfaces of the laminated sheet to obtain a singulated laminate. In the second step, the frequency of the laser beam may be, for example, 5 kHz to 30 kHz, preferably 5 kHz to 28 kHz, or 5 kHz to 25 kHz. Further, the output of the laser beam may be, for example, 3.4 W to 100 W, preferably 5 W to 50 W, or 5 W to 30 W. Examples of the laser beam include a carbon dioxide gas laser, a UV laser, and a YAG laser, and a carbon dioxide gas laser may be used.

The cutting of the laminated sheet by the irradiation with the laser beam is performed by scanning the laminated sheet with the laser beam while allowing the laser beam to intersect the main surfaces of the laminated sheet. The scanning speed of the laser beam may be, for example, 50 mm/s to 100 mm/s, preferably 60 mm/s to 100 mm/s, or 70 mm/s to 100 mm/s. The number of scans with the laser beam per cut surface may be, for example, 1 to 5, preferably 1 to 2.

The irradiation of the laminated sheet with the laser beam may be performed while discharging an inert gas to the vicinity of an irradiation position of the laser beam. By this discharge of an inert gas, contamination of the resulting laminate by a decomposition gas can be inhibited. Examples of the inert gas used for the discharge include a noble gas such as argon and a nitrogen gas, and a nitrogen gas may be used. The amount of the inert gas to be discharged may be, for example, 100 ml/s to 1,000 ml/s, preferably 100 ml/s to 500 ml/s.

In the second step, the laminated sheet to be irradiated with the laser beam may be maintained in a state of being in contact with a support, or in a state where at least the irradiation position of the laser beam is separated from the support. From the standpoint of the workability of the laminated sheet, the laminated sheet may be maintained in a state where at least the irradiation position of the laser beam is separated from the support. In other words, at the irradiation position of the laser beam, the laser beam may be irradiated with space being provided on the side of the main surface of the laminated sheet that is opposite to the main surface irradiated with the laser beam. As a method of maintaining the irradiation position of the laser beam in a state of being separated from the support, for example, the entirety of the laminated sheet portion including a region of the singulated laminate may be maintained such that it is spaced from the support, or a recess, a notch, or the like may be formed at a position of the support that corresponds to the irradiation position of the laser beam so as to maintain the laminated sheet such that a space is provided on the opposite side of the irradiation position of the laser beam.

In the singulated laminate formed by cutting the laminated sheet by irradiation with the laser beam, a cut surface intersecting with the main surfaces constitutes an end surface. The cut surface constituting the end surface of the laminate may be, for example, substantially perpendicular to the main surfaces of the laminate. Further, the cut surface may be formed in a manner to surround the periphery of the laminate. The periphery of the laminate may be surrounded by four flat cut surfaces, or by cut surfaces including at least one curved cut surface.

On the cut surface of the laminate, at least a portion of the end surfaces of the two barrier layers constituting the laminate and at least a portion of the end surface of the wavelength conversion layer are exposed. By forming the cut surface such that at least a portion of the end surface of the wavelength conversion layer is exposed thereon, discoloration of the wavelength conversion member from an end portion with time is inhibited. The details of the exposed state of the end surface of the wavelength conversion layer on the cut surface of the laminate are as described above.

At the cut surface of the laminate, a first modification part may be formed on at least a portion of the end surface of each barrier layer. The first modification part may have, on its surface, at least one oxygen-containing functional group selected from the group consisting of a carboxy group, a hydroxy group, and a carbonyl group. The details of the amount of the oxygen-containing functional group existing on the surface of the first modification part are as described above. Further, the density of the oxygen-containing functional group existing on the surface of the first modification part may be higher than the density of the oxygen-containing functional group existing on the end surfaces of the barrier layers of the laminated sheet prior to the cutting. In other words, a ratio of the density of the oxygen-containing functional group existing on the surface of the first modification part with respect to the density of the oxygen-containing functional group existing on the end surfaces of the barrier layers of the laminated sheet prior to the cutting may be higher than 1, preferably 5 or higher. The details of the ratio of the density of the oxygen-containing functional group existing on the surface of the first modification part with respect to the density of the oxygen-containing functional group existing on the end surfaces of the barrier layers of the laminated sheet prior to the cutting are as described above.

At the cut surface of the laminate, the first modification part may cover the boundaries between the respective barrier layers and the wavelength conversion layer. The details of the covering state of the first modification part at the cut surface of the laminate are as described above.

At the cut surface of the laminate, a second modification part may be formed on at least a portion of the end surface of the wavelength conversion layer. The second modification part may have, on its surface, at least one oxygen-containing functional group selected from the group consisting of a carboxy group, a hydroxy group, and a carbonyl group. The details of the amount of the oxygen-containing functional group existing on the surface of the second modification part are as described above. Further, the density of the oxygen-containing functional group existing on the surface of the second modification part may be higher than the density of the oxygen-containing functional group existing on the end surface of the wavelength conversion layer of the laminated sheet prior to the cutting. In other words, a ratio of the density of the oxygen-containing functional group existing on the surface of the second modification part with respect to the density of the oxygen-containing functional group existing on the end surface of the wavelength conversion layer of the laminated sheet prior to the cutting may be higher than 1, preferably 5 or higher. The details of the ratio of the density of the oxygen-containing functional group existing on the surface of the second modification part with respect to the density of the oxygen-containing functional group existing on the end surface of the wavelength conversion layer of the laminated sheet prior to the cutting are as described above.

As described above, the barrier layers of the laminated sheet may contain a thermoplastic resin. When the barrier layers contain a thermoplastic resin, the first modification part formed on the cut surface of the laminate may contain a thermally denatured product of the thermoplastic resin that is generated at the time of cutting the laminated sheet with a laser beam. Further, as described above, the wavelength conversion layer of the laminated sheet may contain a cured resin of a photocurable composition. When the wavelength conversion layer contains a cured resin, the second modification part formed on the cut surface of the laminate may contain a thermally denatured product of the cured resin that is generated at the time of cutting the laminated sheet with a laser beam.

### EXAMPLES

The present invention will now be described more concretely by way of Examples; however, the present invention is not limited to the below-described Examples.

### REFERENCE EXAMPLE 1: PRODUCTION OF LAMINATED SHEET

### Preparation of Nanoparticle Precursor

As raw materials, 25.2 g of formamidinium hydrobromide (FABr; manufactured by Tokyo Chemical Industry Co., Ltd.), 74.2 g of lead (II) bromide (PbBr₂; manufactured by Stream Chemicals, Inc.), 22.6 g of zirconia balls YTZ having a diameter of 10 mm (yttria-stabilized zirconia; manufactured by AS ONE Corporation), and 5.6 g of zirconia balls YTZ having a diameter of 2 mm (yttria-stabilized zirconia; manufactured by AS ONE Corporation) were placed in an alumina pot. This alumina pot containing the raw materials was mounted on a ball mill rotating stand (AV-1; manufactured by AS ONE Corporation), and the raw materials were mixed at a rotation speed of 160 rpm for 48 hours. Subsequently, as an organic solvent, 50 g of hexane was added to the alumina pot containing the raw materials, and the raw materials were further mixed at a rotation speed of 160 rpm for 3 hours. After the completion of the mixing of the raw materials, the resulting mixture was passed through a nylon mesh having a mesh size of 300 μm by suction filtration to remove the zirconia balls YTZ, whereby a first mixture was obtained in the form of a slurry. This first mixture was suction-filtered and then air-dried for 24 hours in the air atmosphere to obtain a nanoparticle precursor.

The thus obtained nanoparticle precursor had a composition represented by [(NH₂)₂CH] PbBr₃ (hereinafter, also referred to as “FAPbBr₃”). The nanoparticle precursor displayed orange color. The nanoparticle precursor did not emit light even when irradiated with a light having a wavelength of 450 nm.

### Measurement of X-Ray Diffraction Pattern

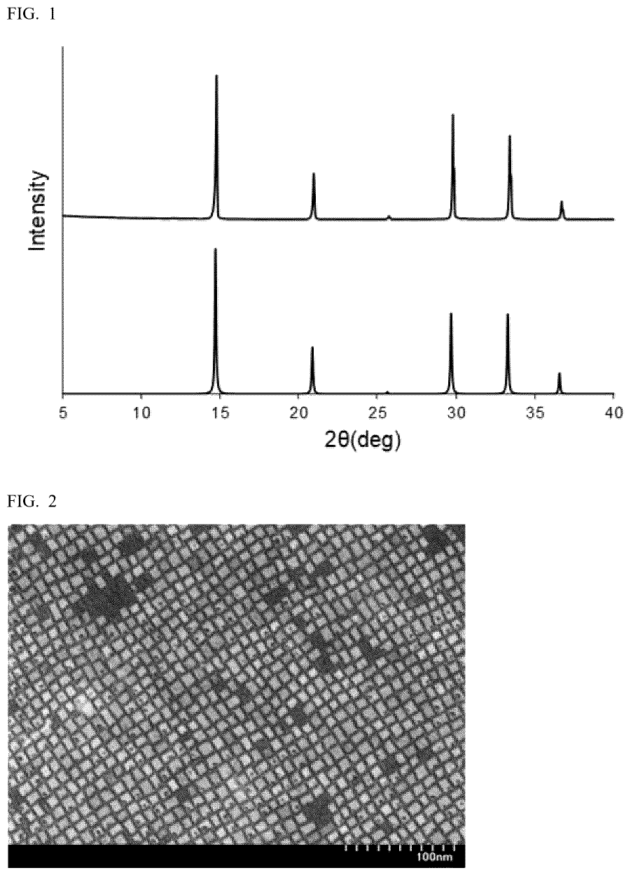

An XRD pattern of the above-obtained nanoparticle precursor was measured by X-ray diffraction (XRD) method using CuKα rays. The measurement of the XRD pattern indicating the diffraction intensity (Intensity) with respect to the diffraction angle (2θ) was performed using an X-ray diffractometer (MiniFlex, manufactured by Rigaku Corporation) under the below-described conditions. The result thereof is shown in FIG. 1.

FIG. 1 shows the XRD pattern (top) of the nanoparticle precursor, and the XRD pattern (bottom) of FAPbBr₃ having an orthorhombic crystal structure, which is registered in ICSD (inorganic Crystal Structure Database). As shown in FIG. 1, the peak positions of the XRD pattern of the nanoparticle precursor were in conformity with the peak positions of the XRD pattern of FAPbBr₃ registered in ICSD. From the XRD pattern of the nanoparticle precursor, the nanoparticle precursor was confirmed to have an orthorhombic crystal structure.

### Preparation of Nanoparticles

The nanoparticle precursor in an amount of 3.15 g was added to a wet microbead mill pulverizer/disperser (LABSTAR Mini; manufactured by Ashizawa Finetech Ltd.) along with 0.94 g of oleylamine (manufactured by Tokyo Chemical Industry Co., Ltd.), 0.31 g of octadecyldimethyl (3-sulfopropyl)ammonium hydroxide (SBE-18; manufactured by Merck KGaA), and 101 g of toluene (manufactured by FUJIFILM Wako Pure Chemical Corporation) as organic solvents, and 422 g of zirconia balls YTZ having a diameter of 0.2 mm (yttria-stabilized zirconia; manufactured by AS ONE Corporation) as a dispersion medium, and the added materials were stirred for 1 hour at a circumferential speed of 14 m/sec and a rotation speed of 4,456 rpm. A mixture obtained by this stirring was passed through a nylon mesh having a mesh size of 25 μm by suction filtration to remove the zirconia balls YTZ and unpulverized coarse nanoparticle precursor, whereby a second mixture was obtained in the form of a slurry. The thus obtained second mixture was placed in a vessel, and centrifuged at 5,000 rpm for 10 minutes using a centrifuge (CN-2060; rotation radius=94 mm; manufactured by AS ONE Corporation) to allow coarse particles to precipitate, after which the resulting supernatant was recovered. The thus recovered supernatant was passed through a syringe filter having a pore size of 0.2 μm to obtain a dispersion containing nanoparticles. The content of the nanoparticles in the dispersion was 0.57% by mass.

The dispersion containing the nanoparticles emitted light when irradiated with a 450-nm light. Transmission Electron Microscope (TEM) Observation of Nanoparticles

The nanoparticles in a solution were observed under a transmission electron microscope (TEM; H-7650; manufactured by Hitachi High-Tech Science Corporation). FIG. 2 shows a TEM image of the nanoparticles.

### Average Particle Size of Nanoparticles

The average particle size of the nanoparticles was determined from TEM images captured at a magnification of ×80,000 to ×200,000. As a TEM grid, a High Resolution Carbon HRC-C10 STEM Cu100P grid (manufactured by Okenshoji, Co., Ltd.) was used. The above-obtained nanoparticles had a spherical shape or a polygonal shape. The average particle size was determined by selecting TEM images of at least three spots, measuring the particle size for all measurable nanoparticles contained in the TEM images, and calculating the arithmetic mean of the thus measured values. Specifically, the average particle size of the nanoparticles was determined by measuring the particle size of each nanoparticle, which was defined as the length of the longest line segment among those line segments connecting any two points on the circumference of the particle observed in a TEM image and passing through the center of the particle, and calculating the arithmetic mean of the particle size of at least 100 nanoparticles. The average particle size of the above-obtained nanoparticles was 11.2 nm.

### Preparation of Nanoparticle IBOA Dispersion

A solution was prepared by mixing 5.0 g of the dispersion containing the nanoparticles (content of nanoparticles: 0.57% by mass) and 2.03 g of isobornyl acrylate (IBOA; manufactured by Tokyo Chemical Industry Co., Ltd.) as a radical polymerizable monomer. While heating this solution at 30° C. under a reduced pressure of 10 mbar using an evaporator, toluene was vaporized over a period of 24 hours to obtain a nanoparticle IBOA dispersion. The content of the nanoparticles in the thus obtained dispersion was 1.4% by mass.

### Emission Characteristics

Emission characteristics were measured for the thus obtained nanoparticle IBOA dispersion. Using a quantum efficiency measurement system (trade name: QE-2100, manufactured by Otsuka Electronics Co., Ltd.), the nanoparticle IBOA dispersion was irradiated with a light having a peak emission wavelength of 450 nm to measure the emission spectrum at room temperature (25° C.). The nanoparticle IBOA dispersion was diluted with a solvent (IBOA) such that the absorbance at 450 nm was adjusted to be 0.15. From the thus obtained emission spectrum, the internal quantum efficiency (%), the peak emission wavelength (nm), and the half-value width (nm) in the emission spectrum were determined. The internal quantum efficiency (%), which is a ratio of photons converted to light emission among those photons absorbed by the nanoparticles, was calculated by dividing the number of emitted photons (%) by the number of absorbed photons (%). The emission characteristics of the nanoparticle IBOA dispersion are shown in Table 1.

TABLE 1

| | Peak emission | Half-value |
|---|---|---|
| Internal quantum | wavelength | width |
| efficiency (%) | (nm) | (nm) |
| 92 | 518 | 24 |

The nanoparticle IBOA dispersion exhibited a high emission efficiency with an internal quantum efficiency of 92%, had a narrow half-value width of 24 nm, and was excellent in color purity. Further, the nanoparticle IBOA dispersion had a peak emission wavelength of 518 nm, and absorbed a light having a peak wavelength of 450 nm to emit a green light.

An acrylic monomer mixed solution was obtained by mixing 0.7 g of dicyclopentanyl acrylate (FA-513AS; manufactured by Showa Denko Materials Co., Ltd.), 0.3 g of EO-modified bisphenol A dimethacrylate (FA-321M; manufactured by Showa Denko Materials Co., Ltd.), and 0.01 g of 2,4,6-trimethylbenzoyl phosphine oxide (TPO; manufactured by FUJIFILM Wako Pure Chemical Corporation) serving as a photopolymerization initiator. Using a planetary centrifugal mixer (MAZERUSTAR; manufactured by KURABO Industries, Ltd.), 0.23 g of the above-obtained nanoparticle IBOA dispersion and 1.0 g of the acrylic monomer mixed solution were mixed to prepare a photocurable composition.

As two barrier layers, barrier films (manufactured by i-Components Co., Ltd., TBF1004) were prepared. The photocurable composition was applied between these two barrier layers using a roll-to-roll applicator, and the resultant was irradiated with ultraviolet rays emitted from a UV irradiator to initiate a monomer polymerization reaction and cure the photocurable composition, whereby a laminated sheet in which the barrier films were adhered to both main surfaces of a wavelength conversion layer having a thickness of 50 μm was produced.

### Example 1

From the thus obtained laminated sheet, a laminate having a rectangular shape of 25 mm on one side (025 mm) was cut out using a carbon dioxide gas laser irradiator at a frequency of 25 kHz, an output of 7.5 W, and a scanning speed of 70 mm/s, in two passes per cross-section, whereby a wavelength conversion member of Example 1 was produced.

### Example 2

A wavelength conversion member of Example 2 was produced in the same manner as in Example 1, except that the output of the carbon dioxide gas laser irradiator was changed to 15 W.

### Example 3

A wavelength conversion member of Example 3 was produced in the same manner as in Example 1, except that the output of the carbon dioxide gas laser irradiator was changed to 30 W.

### Comparative Example 1

A wavelength conversion member of Comparative Example 1 was produced by cutting out a laminate having a rectangular shape of 25 mm on one side (025 mm) from the above-obtained laminated sheet using a cutting machine.

### Evaluation

### 1. Scanning Microscope Observation

For each of the wavelength conversion members produced in Comparative Example 1 and Example 3, an SEM image was obtained as a reflected electron image of a cut surface under a scanning electron microscope (SEM; JSM-IT200 manufactured by JEOL Ltd.) at an acceleration voltage of 5 kV and a probe current of 50 μA. FIG. 4 shows the thus obtained reflected electron image of a cut surface of the wavelength conversion member of Comparative Example 1, which cut surface was obtained using a cutting machine, and FIG. 5 shows the thus obtained reflected electron image of a cut surface of the wavelength conversion member of Example 3, which cut surface was obtained using a laser.

As shown in FIG. 4, at the cut surface of the wavelength conversion member produced in Comparative Example 1, interfacial delamination was observed between the wavelength conversion layer and each of the barrier layers. On the other hand, as shown in FIG. 5, such interfacial delamination between the wavelength conversion layer and each of the barrier layers was inhibited at the cut surface of the wavelength conversion member produced in Example 3.

### 2. Fluorescence Microscope Observation

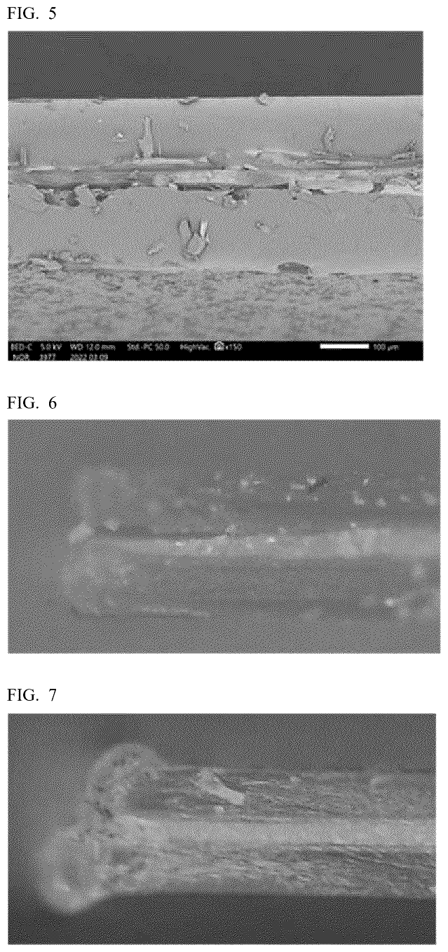

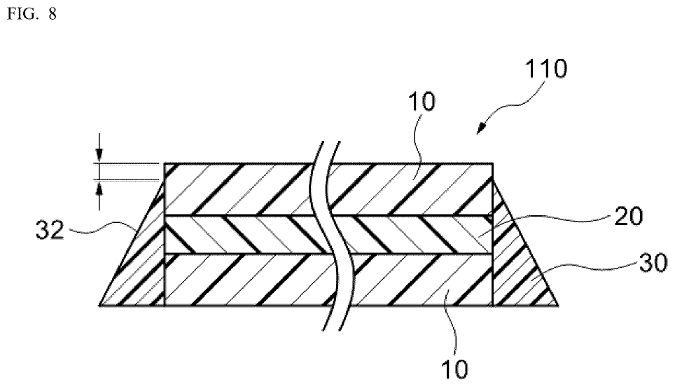

Samples were prepared by dry dicing each of the wavelength conversion members produced in Comparative Example 1 and Example 3 such that the resulting cut end portion was exposed. A cross-section of the end portion of each of the thus prepared samples was observed under a fluorescence microscope (manufactured by OLYMPUS Corporation). FIG. 6 shows the thus obtained fluorescence micrograph of the cross-section of the end portion of the wavelength conversion member according to Comparative Example 1, which cross-section was obtained using a cutting machine, and FIG. 7 shows the thus obtained fluorescence micrograph of the cross-section of the end portion of the wavelength conversion member according to Example 3, which cross-section was obtained using a laser.

Comparing FIG. 6 and FIG. 7, it is seen that a first modification part and a second modification part exist at the cross-section of the wavelength conversion member of Example 3.

### 3. Infrared Absorption Spectrum

For the barrier films used as barrier layers in Reference Example 1, a sample having a modified cut surface was prepared by cutting under the laser irradiation conditions of Example 3. For each of the modified cut surface (first modification part) of the thus prepared sample and a non-modified cut surface (first non-modification part) that was formed using a cutter at a position of 20 mm from the cut surface, an infrared absorption spectrum was measured by an attenuated total reflection (ATR) method using a Fourier transform infrared spectrophotometer (manufactured by Thermo Fisher Scientific K.K.).

From the thus obtained infrared absorption spectra, the peak intensity attributed to CO stretching vibration (peak wavelength=1,725 cm⁻¹; I¹_{CO}), the peak intensity attributed to OH stretching vibration (peak wavelength=3,300 cm⁻¹; I¹_{OH}), and the peak intensity attributed to CH stretching vibration (peak wavelength=2,957 cm⁻¹; I¹_{OH}) in the first modification part that is a laser-formed cut surface of the above-prepared sample were measured, and a peak intensity ratio attributed to CO stretching vibration (I¹_{CO}/I¹_{CH}) and a peak intensity ratio attributed to OH stretching vibration (I¹_{OH}/I¹_{CH}) were each calculated. In addition, the peak intensity attributed to CO stretching vibration (peak wavelength=1,725 cm⁻¹; I²_{CO}), the peak intensity attributed to OH stretching vibration (peak wavelength=3,300 cm⁻¹; I²_{OH}), and the peak intensity attributed to CH stretching vibration (peak wavelength=2,957 cm⁻¹; I²_{CH}) in the first non-modification part that is a cut surface formed using a cutter were measured, and a peak intensity ratio attributed to CO stretching vibration (I²_{CO}/I²_{CH}) and a peak intensity ratio attributed to OH stretching vibration (I²_{OH}/I²_{CH}) were each calculated. Further, using these peak intensity ratios, a ratio (I¹_{CO}/I²_{CO}) of the peak intensity ratio attributed to CO stretching vibration in the first modification part with respect to the peak intensity ratio attributed to CO stretching vibration in the first non-modification part, as well as a ratio (I¹_{OH}/I²_{OH}) of the peak intensity ratio attributed to OH stretching vibration in the first modification part with respect to the peak intensity ratio attributed to OH stretching vibration in the first non-modification part were calculated. The results thereof are shown in Table 2.

TABLE 2

| | | |
|---|---|---|
| First | I¹_{CO}/I¹_{CH} | 10.2 |
| modification part | I¹_{OH}/I¹_{CH} | 0.9 |
| First | I²_{CO}/I²_{CH} | 7.9 |
| non-modification part | I²_{OH}/I²_{CH} | 0.8 |
| First modification part/ | I¹_{CO}/I²_{CO} | 1.29 |
| First non-modification part | I¹_{OH}/I²_{OH} | 1.13 |

The acrylic monomer mixed solution prepared in Reference Example 1 was irradiated with ultraviolet rays under the same conditions as in Reference Example 3 to obtain a cured product. The thus obtained cured product was cut under the laser irradiation conditions of Examples 2 and 3 to obtain samples having a modified cut surface. For each of the modified cut surfaces (second modification parts) of the thus prepared samples and non-modified cut surfaces (second non-modification parts) that were formed using a cutter at a position of 20 mm from the respective cut surfaces, an infrared absorption spectrum was measured using a Fourier transform infrared spectrophotometer (manufactured by Thermo Fisher Scientific K.K.).

From the thus obtained infrared absorption spectra, the peak intensity attributed to CO stretching vibration (peak wavelength=1,725 cm⁻¹; I³_{CO}), the peak intensity attributed to OH stretching vibration (peak wavelength=3,300 cm⁻¹; I³_{OH}), and the peak intensity attributed to CH stretching vibration (peak wavelength=2,957 cm⁻¹; I³_{CH}) in the modified cut surface (second modification part) of the sample prepared under the laser irradiation conditions of Example 2 were measured, and a peak intensity ratio attributed to CO stretching vibration (I³_{CO}/I³_{CH}) and a peak intensity ratio attributed to OH stretching vibration (I³_{OH}/I²³_{CH}) were each calculated. In addition, the peak intensity attributed to CO stretching vibration (peak wavelength=1,725 cm⁻¹; I⁴_{CO}), the peak intensity attributed to OH stretching vibration (peak wavelength=3,300 cm⁻¹; I⁴_{OH}), and the peak intensity attributed to CH stretching vibration (peak wavelength=2,957 cm⁻¹; I⁴_{CH}) in the modified cut surface (second modification part) of the sample prepared under the laser irradiation conditions of Example 3 were measured, and a peak intensity ratio attributed to CO stretching vibration (I⁴_{CO}/I⁴_{CH}) and a peak intensity ratio attributed to OH stretching vibration (I⁴_{OH}/I⁴_{CH}) were each calculated. Further, the peak intensity attributed to CO stretching vibration (peak wavelength=1,725 cm⁻¹; I⁵_{CO}), the peak intensity attributed to OH stretching vibration (peak wavelength=3,300 cm⁻¹; I⁵_{OH}), and the peak intensity attributed to CH stretching vibration (peak wavelength=2, 957 cm⁻¹; I⁵_{CH}) in the non-modified cut surface (second non-modification part) were measured, and a peak intensity ratio attributed to CO stretching vibration (I⁵_{CO}/I⁵_{CH}) and a peak intensity ratio attributed to OH stretching vibration (I⁵_{OH}/I⁵_{CH}) were each calculated. Moreover, using these peak intensity ratios, for Examples 2 and 3, ratios (I³_{CO}/I⁵_{CO} and I⁴_{CO}/I⁵_{CO}) of the peak intensity ratio attributed to CO stretching vibration in the second modification part with respect to the peak intensity ratio attributed to CO stretching vibration in the second non-modification part, as well as ratios (I³_{OH}/I⁵_{OH} and I⁴_{OH}/I⁵_{OH}) of the peak intensity ratio attributed to OH stretching vibration in the second modification part with respect to the peak intensity ratio attributed to OH stretching vibration in the second non-modification part were calculated. The results thereof are shown in Table 3.

TABLE 3

| | | |
|---|---|---|
| Example 2 Second | I³_{CO}/I³_{CH} | 1.28 |
| modification part | I³_{OH}/I³_{CH} | 0.37 |
| Example 3 Second | I⁴_{CO}/I⁴_{CH} | 1.81 |
| modification part | I⁴_{OH}/I⁴_{CH} | 0.46 |
| Second | I⁵_{CO}/I⁵_{CH} | 0.48 |
| non-modification part | I⁵_{OH}/I⁵_{CH} | 0.12 |
| Example 2 Second | I³_{CO}/I⁵_{CO} | 2.67 |
| modification part/Second | I³_{OH}/I⁵_{OH} | 3.08 |
| non-modification part | | |
| Example 3 Second | I⁴_{CO}/I⁵_{CO} | 3.77 |
| modification part/Second | I⁴_{OH}/I⁵_{OH} | 3.83 |
| non-modification part | | |

### 4. High-Temperature High-Humidity Storage Test

The wavelength conversion members of Examples 1 to 3 and Comparative Example 1 were evaluated in the following manner. The wavelength conversion members were left to stand in a thermo-hygrostat chamber (manufactured by ESPEC Corp.) under an atmosphere having a temperature of 60° C. and a relative humidity of 90%. After a lapse of 100 hours, the wavelength converting members were taken out of the thermo-hydrostat chamber and used as post-storage-test samples.

For each of the thus obtained post-storage-test samples, the outer appearance was photographed from a main surface side using a digital camera (manufactured by OLYMPUS Corporation) to obtain an evaluation image. For this evaluation image, an emission intensity profile corresponding to green color, in which the distance from one side of the wavelength conversion member to the other opposing side is plotted on the abscissa, was obtained using image analysis software. From the thus obtained emission intensity profile, a relative emission intensity profile in which an arithmetic mean of the emission intensity values at a total of three spots, which are a midpoint having the same distance from the respective ends of the wavelength conversion member and two spots each positioned at 0.5 mm from the midpoint, was taken as 100% was obtained. In this relative emission intensity profile, the distance (mm) from an end portion corresponding to a relative emission intensity of 90% was determined and defined as an evaluation value of discoloration property. The results thereof are shown in Table 4.

TABLE 4

| | | | | Comarative |
|---|---|---|---|---|
| | Example 1 | Example 2 | Example 3 | Example 1 |
| Evaluation | 2.5 | 2.1 | 2.1 | 3.2 |
| value | | | | |

From Table 4, it is seen that discoloration from an end portion after the high-temperature high-humidity test was inhibited by the formation of a cut surface using a laser.

The wavelength conversion member according to one embodiment of the present disclosure is useful in light sources for various lighting devices, vehicles, displays, and the like. Particularly, the wavelength conversion member can be advantageously applied to backlight units of image display devices using a liquid crystal.

The disclosure of Japanese Patent Application No. 2022-043592 (filing date: Mar. 18, 2022) is hereby incorporated by reference in its entirety. All the documents, patent applications, and technical standards that are described in the present specification are hereby incorporated by reference to the same extent as if each individual document, patent application, or technical standard is concretely and individually described to be incorporated by reference.

What is claimed is:

1-31. (canceled)

32. A wavelength conversion member, comprising a laminate that comprises:
a wavelength conversion layer comprising quantum dots; and
barrier layers including a first barrier layer and a second barrier layer, wherein the first barrier layer is laminated on a main surface of the wavelength conversion layer, and wherein the second barrier layer is laminated on another main surface of the wavelength conversion layer,
wherein
the first barrier layer and the second barrier layer each comprise a first modification part on at least a portion of their end surfaces,
the wavelength conversion layer comprises a second modification part on at least a portion of its end surface, and
the second modification part is at least partially exposed on an end surface of the laminate.

33. The wavelength conversion member according to claim 32, wherein the first modification part and the second modification part each comprise, on their surfaces, at least one functional group selected from the group consisting of a carboxy group, a hydroxy group, and a carbonyl group.

34. The wavelength conversion member according to claim 32, wherein the wavelength conversion layer further comprises a cured resin that is a cured product of a photocurable composition.

35. The wavelength conversion member according to claim 34, wherein the second modification part comprises a thermally denatured product of the cured resin.

36. The wavelength conversion member according to claim 32, wherein the barrier layers comprise a thermoplastic resin.

37. The wavelength conversion member according to claim 36, wherein the first modification part comprises a thermally denatured product of the thermoplastic resin.

38. The wavelength conversion member according to claim 32, wherein the quantum dots comprise at least one selected from the group consisting of perovskite quantum dots, chalcopyrite quantum dots, and indium phosphide quantum dots.

39. The wavelength conversion member according to claim 32, wherein the quantum dots comprise first quantum dots having a peak emission wavelength in a range of 475 nm to 560 nm.

40. The wavelength conversion member according to claim 32, wherein the quantum dots comprise second quantum dots having a peak emission wavelength in a range of 600 nm to 680 nm.

41. The wavelength conversion member according to claim 32, wherein, on the end surface of the laminate, the first modification part covers a boundary between a respective barrier layer and the wavelength conversion layer.

42. The wavelength conversion member according to claim 32, further comprising an end surface covering layer on the end surface of the laminate.

43. The wavelength conversion member according to claim 32, wherein, in an infrared absorption spectrum of the wavelength conversion layer, the second modification part has a peak intensity ratio corresponding to a hydroxy group of 1.2 or higher with respect to that of a non-modification part.

44. The wavelength conversion member according to claim 32, wherein, in the infrared absorption spectrum of the wavelength conversion layer, the second modification part has a peak intensity ratio corresponding to a carbonyl group of 1.2 or higher with respect to that of the non-modification part.

45. A method of producing a wavelength conversion member, the method comprising:
providing a laminated sheet that comprises a wavelength conversion layer comprising quantum dots, and barrier layers including a first barrier layer and a second barrier layer, wherein the first barrier layer is laminated on a main surface of the wavelength conversion layer, and wherein the second barrier layer is laminated on another main surface of the wavelength conversion layer; and
cutting the laminated sheet by irradiation with a laser beam intersecting a main surface of the laminated sheet to obtain a singulated laminate,
wherein the irradiation with the laser beam is performed at a laser beam frequency that is 5 kHz to 30 kHz, a scanning speed that is 50 mm/s to 100 mm/s, and a laser beam output that is 3.4 W to 100 W.

46. The method of producing a wavelength conversion member according to claim 45, wherein, in the irradiation with the laser beam, a number of scans per cut surface is 1 to 5.

47. The method of producing a wavelength conversion member according to claim 45, wherein the irradiation with the laser beam is performed while an inert gas is discharged to an irradiation position of the laser beam.

48. The method of producing a wavelength conversion member according to claim 45, wherein the laser beam is a carbon dioxide gas laser.

49. The method of producing a wavelength conversion member according to claim 45, wherein the irradiation with the laser beam is performed with a space being provided on a side of a main surface of the laminated sheet that is opposite to the main surface irradiated with the laser beam at an irradiation position of the laser beam.

50. The method of producing a wavelength conversion member according to claim 45, wherein an end surface of the wavelength conversion layer is at least partially exposed on a cut surface of the laminate.

51. The method of producing a wavelength conversion member according to claim 45, wherein the laminate comprises, at its cut surface, a first modification part on at least a portion of end surfaces of one or more of the barrier layers.

52. The method of producing a wavelength conversion member according to claim 51, wherein the first modification part comprises, on its surface, at least one functional group selected from the group consisting of a carboxy group, a hydroxy group, and a carbonyl group.

53. The method of producing a wavelength conversion member according to claim 52, wherein, in the first modification part, a ratio of a density of the functional group existing on the surface with respect to a density of the functional group existing on the end surfaces of the one or more of the barrier layers of the laminated sheet is higher than 1.

54. The method of producing a wavelength conversion member according to claim 51, wherein, at the cut surface of the laminate, the first modification part covers a boundary between a respective barrier layer and the wavelength conversion layer.

55. The method of producing a wavelength conversion member according to claim 45, wherein the laminate comprises, at its cut surface, a second modification part on at least a portion of an end surface of the wavelength conversion layer.

56. The method of producing a wavelength conversion member according to claim 55, wherein the second modification part comprises, on its surface, at least one functional group selected from the group consisting of a carboxy group, a hydroxy group, and a carbonyl group.

57. The method of producing a wavelength conversion member according to claim 56, wherein, in the second modification part, a ratio of a density of the functional group existing on the surface with respect to a density of the functional group existing on the end surface of the wavelength conversion layer of the laminated sheet is higher than 1.

58. The method of producing a wavelength conversion member according to claim 45, wherein the wavelength conversion layer further comprises a cured resin that is a cured product of a photocurable composition.

59. The method of producing a wavelength conversion member according to claim 45, wherein the barrier layers comprise a thermoplastic resin.

60. The method of producing a wavelength conversion member according to claim 45, wherein the quantum dots comprise at least one selected from the group consisting of perovskite quantum dots, chalcopyrite quantum dots, and indium phosphide quantum dots.

61. The method of producing a wavelength conversion member according to claim 45, wherein the quantum dots comprise first quantum dots having a peak emission wavelength in a range of 475 nm to 560 nm.

62. The method of producing a wavelength conversion member according to claim 45, wherein the quantum dots comprise second quantum dots having a peak emission wavelength in a range of 600 nm to 680 nm.
